(19) United States
(12) Patent Application Publication
(10) Pub. No.: US 2005/0007361 A1
(43) Pub. Date: Jan. 13, 2005

(54) Current-driven active matrix display panel for improved pixel programming

(75) Inventors: Katsuyuki Fujikura, Kawasaki (JP); Katsumi Abe, Kawasaki (JP); Masamichi Shimoda, Minato-ku (JP)

Correspondence Address: SUGHRUE MION, PLLC, 2100 PENNSYLVANIA AVENUE, N.W., SUITE 800, WASHINGTON, DC, 20037, US

(73) Assignees: NEC ELECTRONICS CORPORATION; NEC CORPORATION

(21) Appl. No.: 10/886,615

(22) Filed: Jul. 9, 2004

(30) Foreign Application Priority Data
Jul. 10, 2003 (JP) 272761/2003

(51) Int. Cl. G09G 5/00

(52) U.S. Cl. 345/204

(57) ABSTRACT

A display device is comprised of a data line driver, a scan line driver, and a display panel. The display panel is composed of a plurality of drive legs disposed between a current output node and a first node having a fixed potential, each of the drive legs including a drive transistor having a source connected to the first node, a capacitor connected between a gate of the drive transistor and a second node having a fixed potential, a first switch connected between the current output node and a drain of the drive transistor, and a second switch connected between the gate and the drain of the drive transistor. The display panel further includes a data line, a third switch connected between the current output node and the data line, a current-driven element, a fourth switch connected between the current output node and the current-driven element.

### BACKGROUND OF THE INVENTION

1. Field of the Invention

The present invention is generally related to driving techniques for current-driven light emitting elements, more particularly, to active matrix driving of current-driven light emitting elements, such as organic light emitting diodes (OLED).

2. Description of the Related Art

OLEDs displays have potential advantages over other display devices, such as liquid crystal displays, including the thin form factor, lightness in weight, wide view angle, and improved suitability for displaying moving pictures. This promotes the development of OLED displays.

A typical OLED display system, as shown in FIG. 1, is composed of a display panel 100, a scan line driver 101, and a data line driver 102. The display panel 100 is comprised of scan lines 103, data lines 104. Pixels, each including an OLED element, are disposed at the respective intersections of the scan and data lines 103, and 104.

Although OLED elements may be voltage-driven or current-driven, the current driving scheme is considered to be preferable compared to the voltage driving scheme. One advantage of the current driving scheme is easy intensity control. As known in the art, the intensity of an OLED element is linearly increased as the increase of the driving current, while being non-linearly increased as the increase of the driving voltage. This implies that the current driving scheme is easier to control the intensity of an OLED element, compared to the voltage driving scheme. Another advantage of the current driving scheme is reduction in long time intensity drift; the intensity of a currently developed OLED for a given driving voltage is severely decreased after being driven for a long period of time, while the decrease in the intensity for a given driving current is relatively small.

OLED displays adopting the current driving scheme can be further classified according to the driving methods: passive-matrix (PM) and active-matrix (AM) driving.

Passive-matrix OLED displays, which are typically comprised of scan lines 103, data lines 104, and OLEDs 105 disposed at the respective intersections as shown in FIG. 2 (each one shown), are advantageous in terms of simple configuration and easy fabrication; however, passive-matrix OLED displays experience increased power consumption and reduced lifetime. In passive-matrix OLED displays, each OLED element emits light only while the associated scan line is selected. This requires each OLED element to instantaneously emit high-intensity light while the associated scan line is selected. Increased instantaneous light intensity undesirably decreases light emitting efficiencies, and thus increases power consumption of OLED displays. Additionally, the increased instantaneous light intensity requires an increased instantaneous drive current, and thus enhances the deterioration of the OLED elements. This undesirably reduces the lifetime of the OLED displays.

In contrast, the active-matrix driving, which can maintain the intensity of each OLED element after data line scanning, effectively reduces the instantaneous intensity of each OLED, and thereby improves power consumption and lifetime.

FIG. 3 illustrates a typical structure of each pixel circuit within a display panel adapted to active-matrix driving. Each pixel includes an OLED element 105, a thin film transistor 106, and a capacitor Cs, and a switch SW0. The thin film transistor 106 is used to drive the OLED element 105, and therefore referred to as the drive transistor 106, hereinafter. One electrode of the OLED element 105 is connected to the circuit ground VSS, and the other electrode is connected to a drain of the drive transistor 106. The drive transistor 106 having a source connected to a power source VDD. The capacitor Cs is connected between the source and gate of the drive transistor 106, and the switch SW0 connected between the gate of the drive transistor 106 and the associated data line 104. The switch SW0 is connected to the associated scan line 103, and controlled in response to a scan signal n_0 received from the scan line driver 101 through the scan line 103.

The operation of this pixel circuit is as follows. During a line address period, the capacitor Cs within the each pixel is programmed. Specifically, the scan line n_0 is activated to turn on the switch SW0. Concurrently, the gate of the drive transistor 106 is set to a voltage Vin by a data line driver in response to the associated pixel data. At the end of the line address period, the switch SW0 is turned off to achieve programming of the capacitor Cs; the capacitor Cs holds the voltage developed thereacross. The capacitor Cs allows the drive transistor 106 to provide the OLED element 106 with a drive current Idrv having a level of β(Vin−VDD−Vt)², where VDD is the power supply voltage developed by the power source VDD, Vt is the threshold voltage of the drive transistor 106, and β is a constant proportional to the mobility μ and the ratio (W/L) of the gate width W to the gate length L of the drive transistor 106.

One of the issues of active-matrix driving is nonuniformity in intensity caused by inherent variations in the characteristics of the thin film transistors, including threshold voltages and motilities. The variations in the threshold voltages and motilities undesirably cause nonuniformity in the drive currents provided for the OLED elements, and this results in nonuniformity in intensity.

Several approaches have been proposed for improving uniformity in intensity. A first approach is the use of a sub-field method as disclosed in Japanese Open Laid Patent application No. Jp-A 2001-5426. The sub-field method involves feeding a constant drive current to each OLED element for a period of time that depends on the desired intensity. This patent application additionally discloses that disposing a resister between the drive transistor and the OLED element effectively improves uniformity in the drive current.

A second approach is adopting a pixel circuit structure adapted to compensate variations in threshold voltages of drive transistors, as shown in FIG. 4. This approach is disclosed in “Design of an Improved Pixel for a Polysilicon Active-Matrix Organic LED Display”, R. M. A. Dawson et al, SID 98 Digest pp. 11-14. Referring to FIG. 4, the disclosed pixel circuit includes an OLED element 105, a drive transistor 106, a pair of capacitors Cs1 and Cs2, and switches SW0, SW1, and SW2.

The operation of the pixel circuit is as follows. The operation of the pixel circuit begins with an autozero phase. During the aurozero phase, the switches SW0 and SW1 are turned on, and the switch SW2 is turned off with the data line 104 set to a predetermined voltage. This develops voltages corresponding to the threshold voltage of the drive transistor 106 across the capacitors Cs1 and Cs2. After the autozero phase, the switch SW2 is turned on in place of the switch SW1, and a voltage Vin corresponding to the pixel data is applied to the capacitor Cs2 through the data line 104. Applying the voltage Vin to the capacitor Cs2 pulls up the potential of the gate of the drive transistor 106 to a level dependent on both the threshold voltage of the drive transistor 106 and the pixel data.

This operation effectively compensates the threshold variation of the drive transistor 106, and thereby eliminates the effect of the threshold variation on the drive current through the OLED element 105.

A third approach is using a current mirror for driving each OLED element as disclosed in Japanese Patent Application No.3252897. The third approach addresses eliminating the effect of voltage drops across data lines through providing current signals in place of voltage signals for programming pixels; the current signals are free from the effect of the resistance of data signals.

More specifically, as shown in FIG. 5, the disclosed pixel circuit includes a current mirror composed of a drive transistor 106 and an input transistor 107, a capacitor Cs, and switches SW0 and SW1.

The operation of the pixel circuit shown in FIG. 5 is as follows. During the line addressing period, the switches SW0 and SW1 are turned on to feed a signal current Iin for the input transistor 107 from a data line driver. The data current signal Iin develops a voltage across the capacitor Cs that is necessary for the drive transistor 106 to drive the signal current Iin.

After the line addressing period is terminated, the switches SW0 and SW1 are turned off, and the data line driver stops feeding the signal current Iin; however, the drive transistor 106 continues to feed the current Iin to the OLED element 105, because the gate to source voltage of the drive transistor 106 is maintained by the capacitor Cs.

A fourth approach is adopting a current copier for driving each OLED element as shown in FIG. 6. The current copier architecture involves programming a capacitor connected to the gate of the drive capacitor through providing a programming current dependent on the pixel data, and then providing a drive current for the OLED element with the gate to source voltage of the drive transistor maintained by the capacitor.

More specifically, the pixel circuit shown in FIG. 6 is composed of an OLED element 105, a drive transistor 106, a capacitor Cs, and switches SW0, SW1, and SW2.

The operation of the pixel circuit shown in FIG. 6 is as follows. When the line addressing period is initiated, the switches SW0 and SW1 are turned on, and the switch SW2 is turned off. A signal current Iin corresponding to the associated pixel data is then provided through the drive transistor 106. The signal current Iin develops a voltage across the capacitor Cs so that the developed voltage is a voltage necessary for the drive transistor 106 to drive the signal current Iin.

At the end of the line addressing period, the switches SW0 and SW1 are turned off, and the switch SW2 is turned on. This allows the drive transistor 106 to provide a drive current for the OLED element 105 dependent on the voltage across the capacitor Cs so that the drive current is identical to the signal current Iin.

This approach effectively eliminates the effect of the variations in the characteristics of the drive transistor 106, because the gate to source voltage of the drive transistor 106 is maintained by the capacitor Cs so that the drive current is identical to the signal current Iin.

One drawback of the fourth approach is that the operation procedure is not suitable for driving large-sized and/or fine display panels. In order to improve the lifetime and power consumption, the fourth approach requires reduction in the instantaneous drive current. However, the reduction in the instantaneous drive current leads to an undesirable increase in the duration necessary for charging and discharging the data lines, because the signal current provided from the data line driver, which is also used for charging and discharging the data lines is identical to the instantaneous drive current. This problem is especially serious for large-sized display panels whose data lines have a large capacitance, and fine display panels which require reduced charging/discharging time.

In some situations, the increase in the charging/discharging time may cause a problem that programming of the pixels is not completed during a line addressing period. For a VGA display panel, which includes 640×480 pixels, for example, the duration τ_{d} necessary for charging a data line is approximately 200 μs when the data line driver develops a signal current of 1 μA, the capacitance of the data line is 25 pF, and the necessary voltage change on the data line is 4 V, as understood by the following equation:

$$\begin{matrix}{τ}_{d} = 50 ( pf ) \times 4 ( V ) / 1 ( μ A ) , \\ = 200 ( μ s ) .\end{matrix}$$

However, the line addressing period τₛ for a VGA display panel is typically 34.7 μs for the frame frequency of 60 Hz, as is understood by the following equation:

$$\begin{matrix}{τ}_{s} = \{ 1 / ( 60 \times 480 ) \} \times {10}^{6} , \\ = 34.7 μs .\end{matrix}$$

This implies that the typical line addressing period is not enough to charge and discharge the data lines.

In order to overcome this problem, a fifth approach is known in the art. The fifth approach involves a pixel structure shown in FIG. 6. In the fifth approach, the pixel structure is modified from that in the fourth approach so that the pixel structure additionally includes a switch SW3 connected in parallel to the OLED element 105.

The different in the operation procedure between the fourth and fifth approaches that a blanking period is disposed between the line addressing period and the illuminating period, and thereby reduces the duration of the illuminating period. During the blanking period, the switch SW2 is turned off with the switch SW3 turned on to thereby stop emitting light from the OLED element 105. The duration of the blank period is determined so that the OLED element 105 emits light at desired intensity.

Reducing the duration of the illuminating period through disposing the blanking period allows the data line drive to increase the signal current Iin, and thereby reduces the charging/discharging time. For example, determining the illuminating period as being one sixth of the frame period allows the signal current Iin to be increased up to six times as large as the original one.

The switch SW3, which is additionally disposed in parallel to the OLED element 5, allows the OLED element 5 to rapidly stop emitting light through short-circuiting the electrodes of the OLED element 5 at the beginning of the blanking period.

However, an excessive reduction in the duration of the illuminating period requires an increase in the instantaneous drive current. This undesirably increases the power consumption, and reduces the lifetime of the OLED element.

Accordingly, there is a need for increasing a signal current provided for each pixel through a data line with a reduced instantaneous drive current provided for the associated OLED element.

Still another approach is known in Japanese Patent Application No. Jp-A 2000-347623. The pixel structure disclosed in this patent application includes a plurality of drive legs connected in parallel between a power source and an OLED element. Each of the drive legs includes a drive transistor and a resistor connected in series. In this approach, each drive transistor functions as a digital switch; one or more drive transistors are selected in response to the pixel data, and the selected drive transistors are turned on at the same time to achieve gray scale. The drive current is mainly controlled by the resistor disposed in each drive leg, and thus the drive current is almost free from the effect of the variations in the characteristics of the drive transistors. However, this approach does not address rapidly driving data lines.

### SUMMARY OF THE INVENTION

The present invention generally addresses providing an improved driving technique for current-driven elements, such as OLED elements.

Particularly, one object of the present invention is to provide a driving technique for increasing a signal current provided for each pixel through a data line with a reduced instantaneous drive current provided for the associated OLED element.

In an aspect of the present invention, a display device is comprised of a data line driver, a scan line driver, and a display panel. The display panel includes a plurality of drive legs between a current output node and a first node having a fixed potential. Each of the drive legs is composed of a drive transistor having a source connected to the first node, a capacitor connected between a gate of the drive transistor and a second node having a fixed potential, a first switch connected between the current output node and a drain of the drive transistor, and a second switch connected between the gate and the drain of the drive transistor. The display panel further includes a data line, a third switch connected between the current output node and the data line, a current-driven element, and a fourth switch connected between the current output node and the current-driven element. During a programming period, the scan line driver turns on the first to third switches with the fourth switch turned off, and the data line driver develops a programming current through the data line. During a driving period following the programming period, on the other hand, the scan line driver turns on the fourth switch with the second and third switches turned off, and sequentially turns on the first switches of the drive legs.

The second node may be connected to the first node, and the fixed potential on the second node is identical to that on the first potential.

Preferably, the second switches are turned off at the end of the programming period before the third switch is turned off.

During a blanking period following the driving period, the scan line driver preferably controls the first to fourth switches so that no drive current is provided for the current-driven element from the drive legs.

When the driving period includes first and second illuminating periods, and an intermediate blanking period disposed between the first and second illuminating periods, it is preferable that the scan line driver turns on one of the first switches of the drive legs during the first illuminating period, that the scan line driver controls the first to fourth switches during the intermediate blanking period so that no drive current is provided for the current-driven element from the drive legs, and that the scan line driver turns on another of the first switches of the drive legs during the second illuminating period.

In a preferred embodiment, each of the drive legs further includes a cascading drive transistor having a source connected to the drain of the drive transistor, and a drain connected to the first switch, and another capacitor connected between a gate of the another drive transistor and a third node having a fixed potential. In this case, the third node is preferably connected to the first node, and the fixed potential on the third node is identical to that on the first node.

In another preferred embodiment, the display panel further includes an additional capacitor, and each of the drive legs further comprises a cascading drive transistor having a source connected to the drain of the drive transistor, and a drain connected to the first switch with gates of the cascading drive transistors of the drive legs commonly coupled together, and the additional capacitor is connected between the commonly coupled gates of the cascading drive transistors and a third node having a third potential.

It is also preferable that the display panel further includes an additional switch connected between the commonly coupled gates and the current output node, and the scan line driver turns on the additional switch during the programming period.

The current-driven element may include an OLED element.

In another aspect of the present invention, a display device is comprised of a data line driver, a scan line driver, and a display panel. The display panel includes a plurality of drive legs connected between a current output node and a first node having a fixed potential. Each of the drive legs includes a drive transistor having a source connected to the first node, and a first switch connected between the current output node and a drain of the drive transistor. The gates of the drive transistors of the drive legs are commonly coupled together. The display panel further includes a capacitor connected between the commonly coupled gates and a second node having a fixed potential, a current-driven element connected to the current output node, a data line, and a third switch connected between the data line and the drains of the drive transistors of the drive legs. During a programming period, the scan line driver turns on the first and third switches, and the data line driver provides a programming current through the data line to develop currents through the drive transistors of the drive legs. During a driving period following the programming period, on the other hand, the scan line driver sequentially turns on the first switches of the drive legs with the third switch turned off.

In a preferred embodiment, the display panel further includes, a set of second switches for providing electrical connections among the drains of the drive transistors of the drive legs; and a fourth switch connected between the commonly coupled gates and one of the drains of the drive transistors. In this preferred embodiment, the scan line driver turns on the set of second switches and the fourth switch during the programming period, while turning off the set of second switches and the fourth switch during the driving period.

In another preferred embodiment, the display panel further includes a second switch connected between the commonly coupled gates of the drive transistors and the current output node. In this embodiment, the third switch is connected between the current output node and the data line, and the scan line driver turns on the second switch during the programming period, while turning off the second switch during the driving period.

In this case, it is preferable that the display panel preferably further includes a first MOS transistor having a source and a drain coupled together, the source and drain being connected to the commonly coupled gates of the drive transistors, and that the second switch includes a second MOS transistor, one of a source and a drain of the second MOS transistor being connected to the source and drain of the first MOS transistor, and another being connected to the current output node.

In another preferred embodiment, the display panel further includes a second switch connected between the commonly coupled gates of the drive transistors and the data line, and the third switch is connected between the current output node and the data line. In this case, the scan line driver turns on the second switch during the programming period, while turning off the second switch during the driving period.

In still another preferred embodiment, the display panel further includes a fifth switch connected in parallel to the current-driven element, and, the scan line driver controls the first and third switches with the fifth switch turned on during a blanking period following the driving period, so that no drive current is provided for the current-driven element from the drive leg.

In still another preferred embodiment, each of the drive legs further includes a cascading drive transistor having a source connected to the drain of the drive transistor, and a drain connected to the first switch, the gates of the cascading drive transistors of the drive legs being commonly coupled together. In this case, the display panel further includes an additional capacitor connected between the commonly coupled gates of the cascading drive transistors and a third node having a fixed potential, and the third switch is connected between the data line and the current output node.

In still another aspect of the present invention, a display device is comprised of a data line driver, a scan line driver, and a display panel. The display panel includes a plurality of drive legs connected between a current output node and a first node having a fixed potential. Each of the drive legs includes drive transistor having a source connected to the first node, and a first switch connected between the current output node and a drain of the drive transistor, the gates of the drive transistors of the drive legs being commonly coupled together. The display panel further includes a capacitor connected between the commonly coupled gates and a second node having a fixed potential, a programming transistor having a gate connected to the commonly coupled gates, and a source connected to the first node, a current-driven element connected to the current output node, a data line, and a third switch connected between the data line and the drain of the programming transistor. During a programming period, the scan line driver turns on the first and third switches, and the data line driver provides a programming current for the programming transistor through the data line. During a driving period following the programming period, on the other hand, the scan line driver sequentially turns on the first switches of the drive legs with the third switch turned off.

In a preferred embodiment, the display panel further includes a second switch disposed between the gate and drain of the programming transistor, and the scan line driver turns on the second switch during the programming period, while turning off the second switch during the driving period.

In another preferred embodiment, the display panel further includes a second switch disposed between the data line and the gate of the programming transistor, and the scan line driver turns on the second switch during the programming period, while turning off the second switch during the driving period.

In still another preferred embodiment, the display panel further includes a second switch disposed between the commonly coupled gates of the drive transistors and the gate of the programming transistor, and the scan line driver turns on the second switch during the programming period, while turning off the second switch during the driving period.

### BRIEF DESCRIPTION OF THE DRAWINGS

FIG. 1 is a block diagram of a typical OLED display;

FIG. 2 is a circuit diagram illustrating a typical pixel structure of a passive-matrix OLED display;

FIG. 3 is a circuit diagram illustrating a typical pixel structure of an active-matrix OLED display;

FIG. 4 is a circuit diagram illustrating a pixel structure in connection with the second conventional approach for improving uniformity in intensity;

FIG. 5 is a circuit diagram illustrating a pixel structure in connection with the third conventional approach for improving uniformity in intensity;

FIG. 6 is a circuit diagram illustrating a pixel structure in connection with the fourth conventional approach for improving uniformity in intensity;

FIG. 7 is a circuit diagram illustrating a pixel structure in connection with the fifth conventional approach for improving uniformity in intensity;

FIG. 8 is a block diagram illustrating an OLED display in accordance with the present invention;

FIG. 9 is a circuit diagram illustrating the structure of each pixel of the OLED display in a first embodiment;

FIG. 10 is a timing chart illustrating an exemplary operation of the OLED display in the first embodiment;

FIG. 11A is a schematic diagram illustrating a programming operation of the OLED display in the first embodiment;

FIG. 11B is a schematic diagram illustrating a driving operation of the OLED display in the first embodiment;

FIG. 12 is a timing chart illustrating a preferred operation of the OLED display in the first embodiment;

FIG. 13 is a circuit diagram illustrating the structure of each pixel of the OLED display in a second embodiment;

FIG. 14 is a timing chart illustrating an exemplary operation of the OLED display in the second embodiment;

FIG. 15 is a circuit diagram illustrating the structure of each pixel of the OLED display in a third embodiment;

FIG. 16 is a timing chart illustrating an exemplary operation of the OLED display in the third embodiment;

FIG. 17 is a circuit diagram illustrating the structure of each pixel in a fourth embodiment;

FIG. 18 is a timing chart illustrating an exemplary operation of the OLED display in the fourth embodiment;

FIG. 19 is a circuit diagram illustrating the structure of each pixel in an alternative embodiment;

FIG. 20 is a circuit diagram illustrating the structure of each pixel in a fifth embodiment;

FIG. 21 is a timing chart illustrating an exemplary operation of the OLED display in the fifth embodiment;

FIG. 22 is a circuit diagram illustrating the structure of each pixel in a sixth embodiment;

FIG. 23 is a circuit diagram illustrating the structure of each pixel in a seventh embodiment;

FIG. 24 is a circuit diagram illustrating the structure of each pixel in an eighth embodiment;

FIG. 25 is a circuit diagram illustrating the structure of each pixel in a ninth embodiment;

FIG. 26 is a circuit diagram illustrating the structure of each pixel in an alternative embodiment;

FIG. 27 is a circuit diagram illustrating the structure of each pixel in another alternative embodiment;

FIG. 28 is a circuit diagram illustrating the structure of each pixel in a tenth embodiment;

FIG. 29 is a timing diagram illustrating an exemplary operation of the OLED display in the tenth embodiment;

FIG. 30 is a circuit diagram illustrating the structure of each pixel in an alternative embodiment; and

FIG. 31 is a circuit diagram illustrating the structure of each pixel in another alternative embodiment.

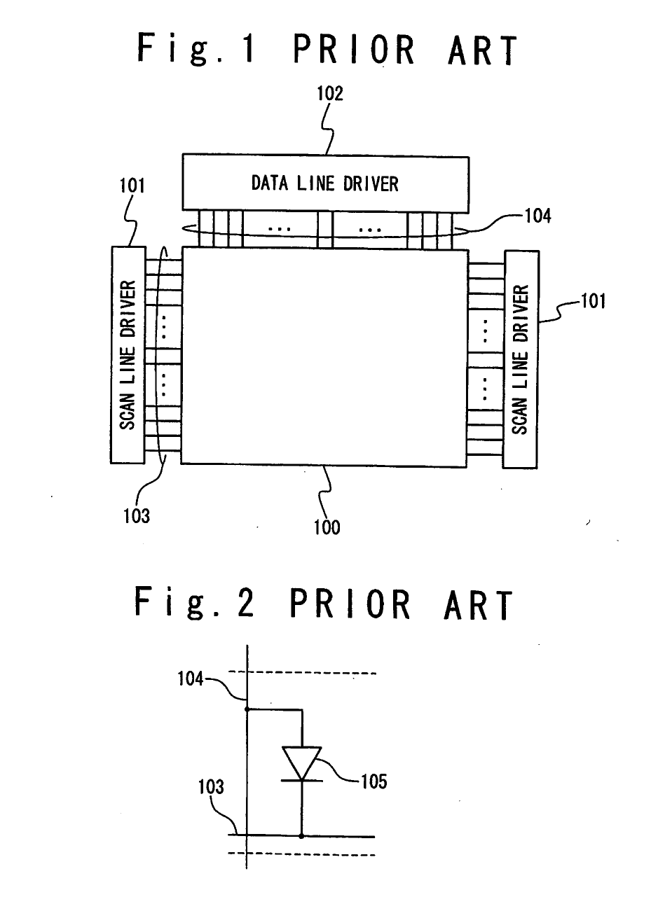

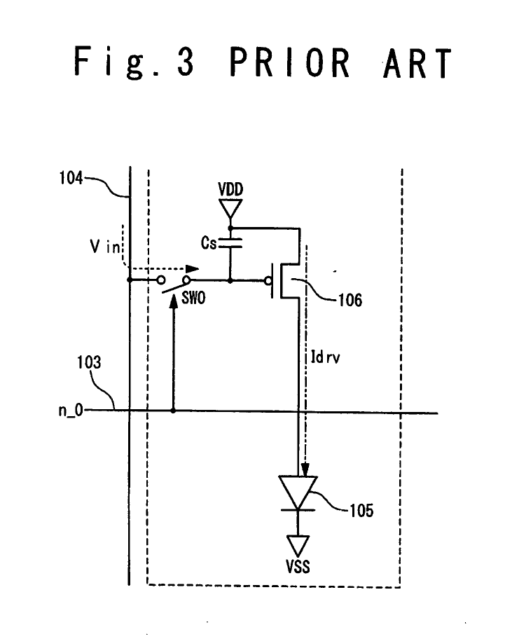

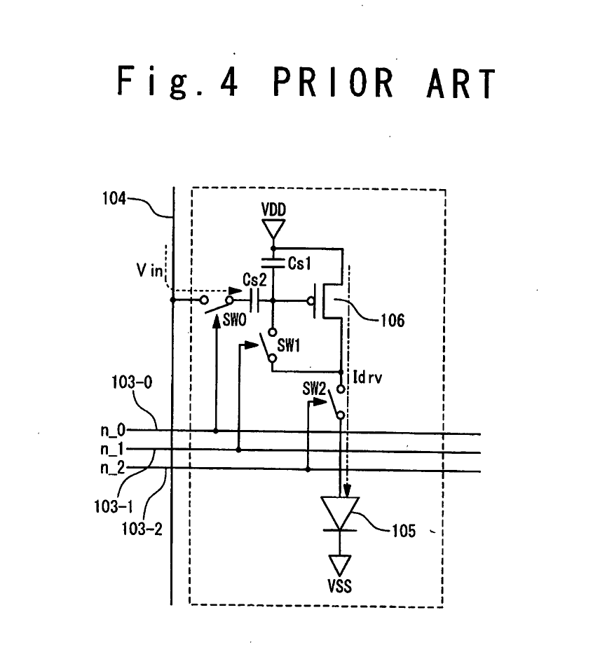

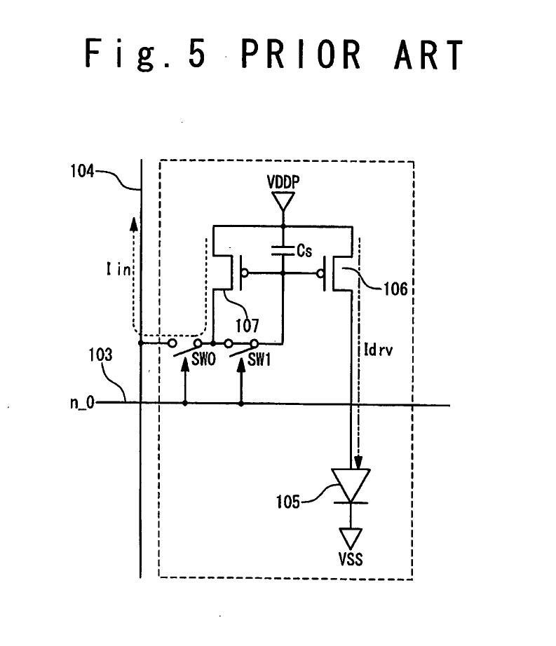

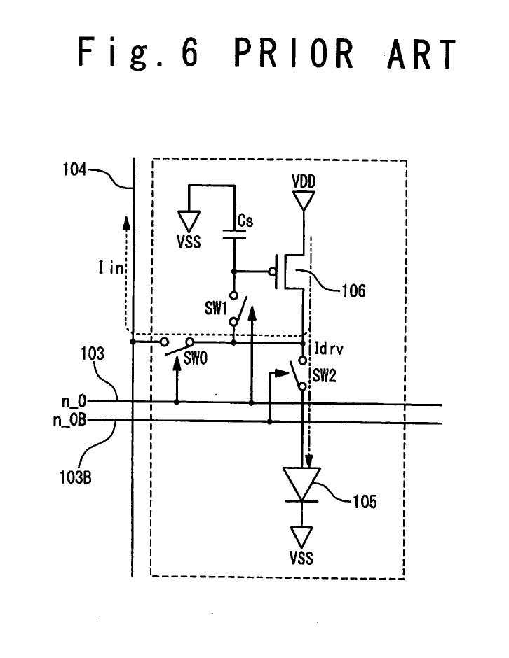

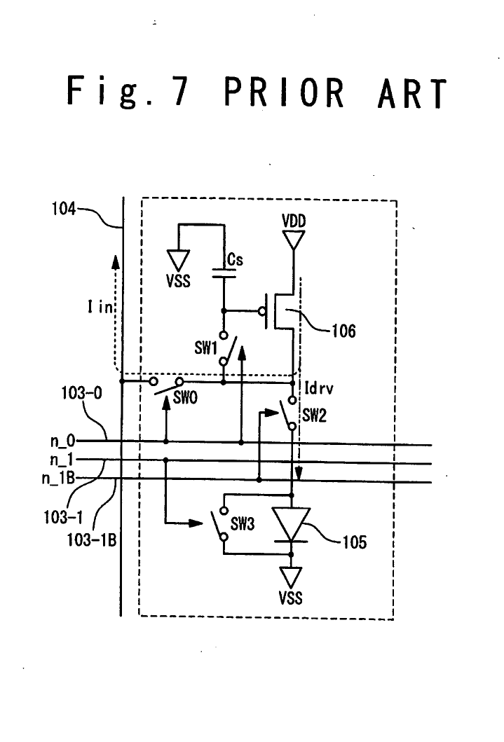

### DESCRIPTION OF THE PREFERRED EMBODIMENTS

Preferred embodiments of the present invention are described below in detail with reference to the attached drawings. It should be noted that identical, similar or corresponding elements are denoted by the identical numeral in the drawings.

### First Embodiment

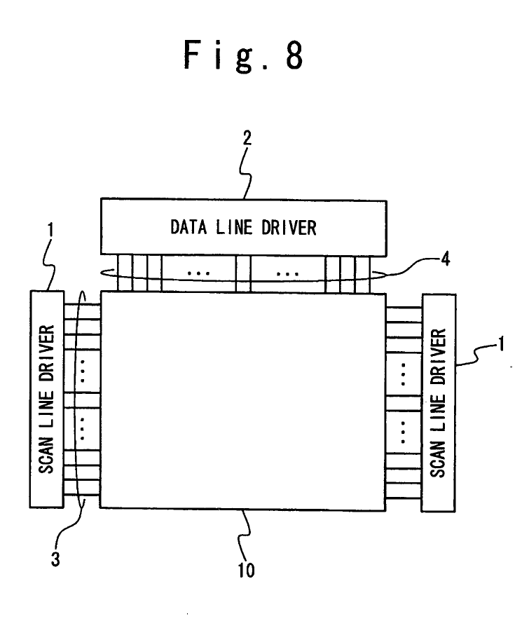

As shown in FIG. 8, an OLED display in a first embodiment is composed of a display panel 10, a scan line driver 1, and a data line driver 2. The display panel 10 is comprised of scan lines 3, and data lines 4. The data lines 4 are driven by the data line driver 2, while the scan lines 3 are scanned by the scan line driver 1.

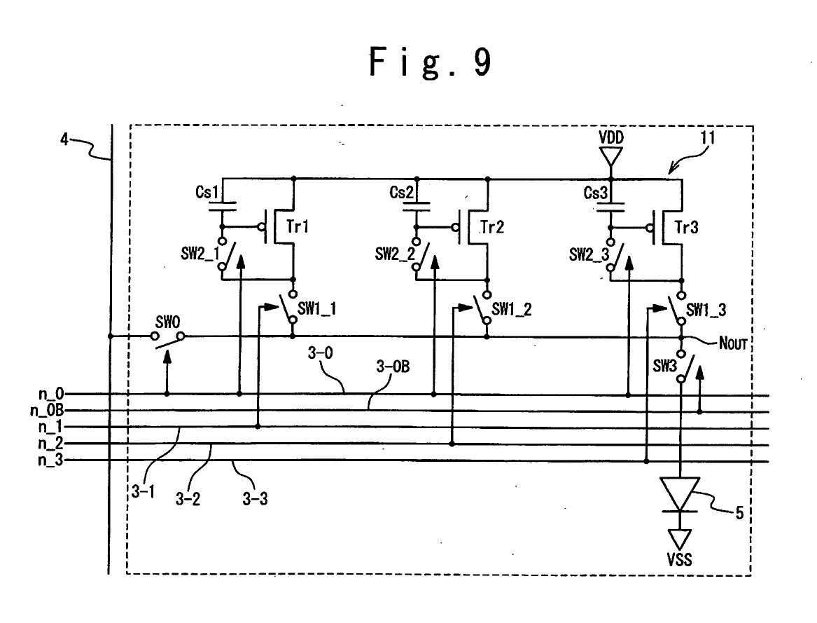

Pixels, each including an OLED element and a pixel circuit, are arranged in rows and columns at the intersections of the scan and data lines 3 and 4. FIG. 9 is a circuit diagram of each pixel, in which the pixel circuit is designated by numeral 11, and the OLED element is designated by numeral 5.

The pixel circuit 11 includes three drive legs connected in parallel between a current output node N_{OUT} and a power source VDD providing a power supply level; the drive legs being composed of PMOS thin film transistors Tr1 to Tr3, respectively. The PMOS transistors Tr1 to Tr3 are used to provide a drive current for the OLED element 5 through the current output node N_{OUT}, and therefore, these PMOS transistors are referred to as the drive transistors Tr1 to Tr3, hereinafter. The sources of the drive transistors Tr1 to Tr3 are connected to the power source VDD, and the drains of the drive transistors Tr1 to Tr3 are coupled to the current output node N_{OUT} through switches SW1_1 to SW1_3, respectively. The switches SW_1 to SW1_3 are used to select the drive transistors Tr1 to Tr3.

Capacitors Cs1 to Cs3 are connected between the power source VDD and the gates of the drive transistors Tr1 to Tr3, respectively. As described below, the capacitors Cs1 to Cs3 are used to program drive currents to be provided for the OLED element 5 as the voltages thereacross.

Switches SW2_1 to SW2_3 are connected between the gates and drains of the drive transistors Tr1 to Tr3, respectively. The switches SW2_1 to SW2_3 provide connections between the gates and drains of the drive transistors Tr1 to Tr3, while the capacitors Cs1 to Cs3 are programmed.

The current output node N_{OUT} is coupled to one terminal of the OLED element 5 through a switch SW3. The other terminal of the OLED element 5 is connected to a power source VSS providing the circuit ground. The switch SW3 is used to allow a drive current to be provided for the OLED element 5.

Finally, the current output node N_{OUT} is coupled to the associated data line 4 through a switch SW0. The switch SW0 provides a current path for programming the capacitors Cs1 to Cs3.

The switches SW1_1 to SW1_3, SW2_1 to SW2_3, SW3, and SW0 are controlled by five scan lines, designated by numerals 3-0, 3-0B, 3-1, 3-2, and 3-3, respectively. The switches SW1_1 to SW1_3 are connected to the scan lines 3-1 to 3-3 receiving scan signals n_1 to n_3 from the scan line driver 1, respectively. The switches SW1_1 to SW1_3 are turned on when the scan signals n_1 to n_3 is activated, typically set high. The switches SW2_1 to SW2_3 are connected to the scan line 3-0 receiving a scan signal n_0 from the scan line driver 1. The switches SW2_1 to SW2_3 are turned on when the scan signal n_0 is activated. Finally, the switches SW3 and SW0 are connected to the scan lines 3-0B and 3-0, respectively. The scan line 3-0B receives a scan signal n_0B complementary to the scan signal n_0 from the scan line driver 1; it should be noted that a symbol “B” attached to the end of a numeral indicates that the associated signal is a complementary signal to another signal. The switch SW3 is turned on in response to activation of the scan signal n_0B, while the switch SW0 is turned on in response to activation of the scan signal n_0.

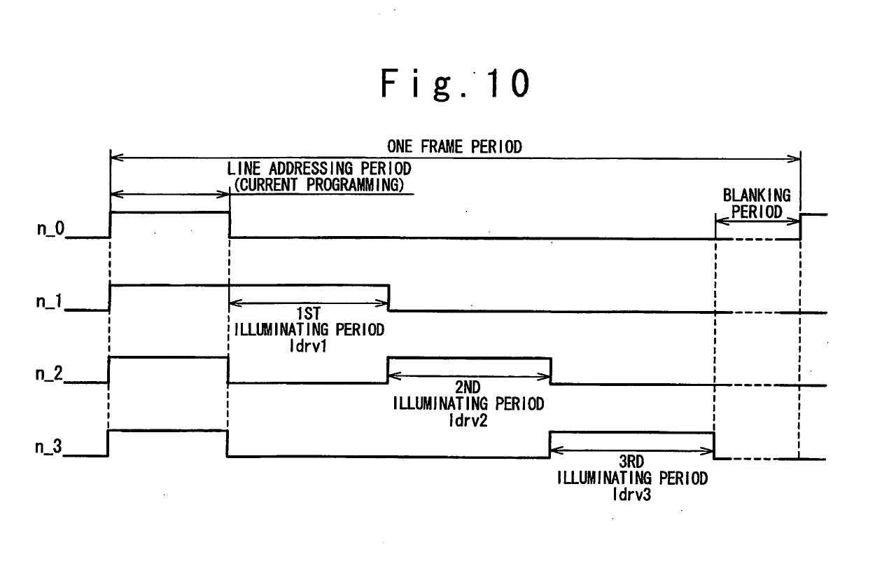

FIG. 10 is a timing chart illustrating an exemplary operation of the pixel circuit. Each frame period is divided into a line addressing period, first to third illuminating period, and a blanking period.

During the line addressing period, the rows of the pixels are sequentially selected, and the capacitors Cs1 to Cs3 in each pixel are programmed in response to the associated pixel data. Specifically, the scan signals n_0 to n_3 are activated to turn on the switches SW0, SW1_1 to SW1_3, and SW2_1 to SW2_3. It should be noted that the scan signal n_0B, complementary to the scan signal n_0 is deactivated to turn off the switch SW3. This allows the drive transistors Tr1 to Tr3 to be connected in parallel between the data line 4 and the power source VDD with the gates and drains connected.

Concurrently, a programming current Iin corresponding to the associated pixel data is provided for the pixel circuit 11 from the data line driver 2 through the associated data line 4. The programming current Iin is delivered to the drive transistors Tr1 to Tr3 to develop currents Ii1 to Ii3 through the drive transistors Tr1 to Tr3, respectively. This results in that the gate to source voltages of the drive transistors Tr1 to Tr3 settle to voltages that are necessary to drive the currents Ii1 to Ii3, respectively. The capacitors Cs1 to Cs3 are programmed to hold the gate to source voltages corresponding to the currents Ii1 to Ii3, respectively. At the end of the addressing period, as shown in FIG. 10, the scan line n_0 is deactivated to turn off the switches SW0, SW2_1 to SW2_3.

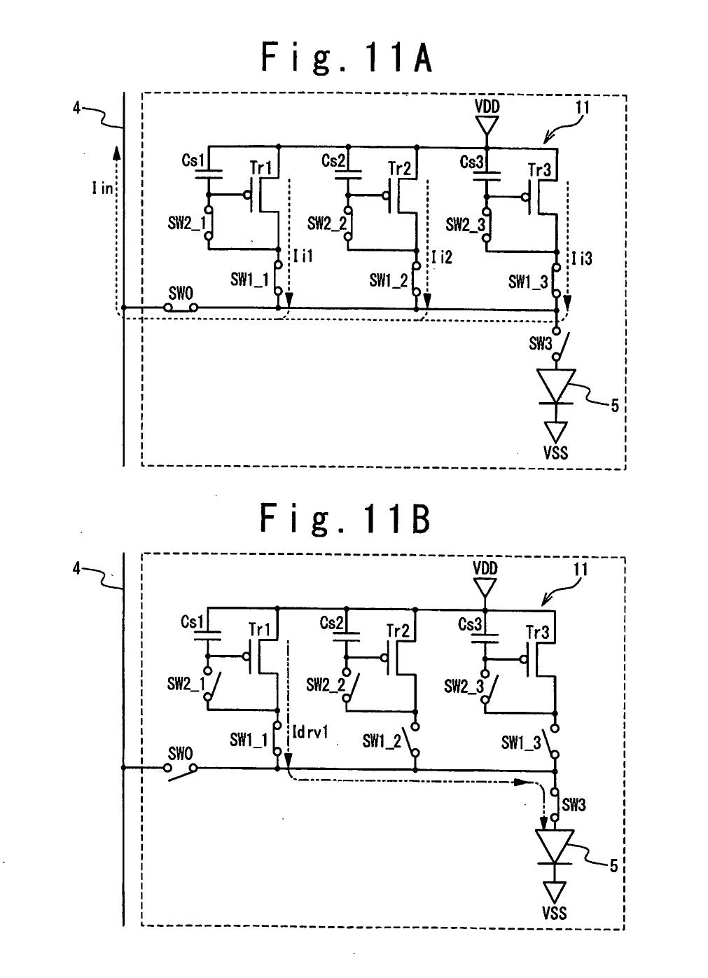

The line addressing period is followed by the first illuminating period. During the first illuminating period, as shown in FIG. 11B, the scan lines n_0, n_2, and n_3 are deactivated to turn off the switches SW0, SW2_1 to SW2_3, SW1_2, and SW1_3, while the scan lines n_0B and n_1 are activated to turn on the switches SW1_1 and SW3. This results in that the drive transistor Tr1 is connected between the power sources VDD and VSS. The drive transistor Tr1 is operated in saturation state to develop a drive current Idrv1 through the OLED element 5 so that the level of the drive current Idrv1 is identical to that of the current Ii1. This allows the OLED element 5 to emit light so that the intensity of the OLED element 5 depends on the drive current Idrv1 during the first illuminating period.

The first illuminating period is followed by the second illuminating period. During the second illuminating period, as shown in FIG. 10, the scan signal n_2 is activated in place of the scan signal n_1, and thus the switch SW1_2 is turned on in place of the switch SW1_1. This allows the drive transistor Tr2 to develop a drive current Idrv2 through the OLED element 5 so that the level of the drive current Idrv2 is identical to that of the current Ii2. The OLED element 5 is driven by the drive current Idrv2 to emit light. The intensity of the OLED element 5 depends on the drive current Idrv2 during the second illuminating period.

Correspondingly, the second illuminating period is followed by the third illuminating period. During the second illuminating period, the scan signal n_3 is activated in place of the scan signal n_2, and thus the switch SW1_3 is turned on in place of the switch SW1_2. This allows the drive transistor Tr3 to develop a drive current Idrv3 through the OLED element 5 so that the level of the drive current Idrv3 is identical to that of the current Ii3. The OLED element 5 is driven by the drive current Idrv3 to emit light. The intensity of the OLED element 5 depends on the drive current Idrv3 during the third illuminating period.

The third illuminating period is followed by the blanking period. During the blanking period, the scan signals n_0 to n_3 are deactivated to turn off the switches SW1_1 to SW1_3, the switches SW2_1 to SW2_3, and SW0, while the scan signal n_0B is activated to turn on the switch SW3. This results in that the drive transistors Tr1 to Tr3 are disconnected from the OLED element 5, and no drive current is provided for the OLED element 5. The OLED element 5 does not emit light during the blanking period.

This procedure is repeatedly performed for every frame period.

The pixel architecture and operation procedure thus-described effectively increase the programming current Iin developed through the associated data line 4, while decreasing the instantaneous drive current through the OLED element 5. Specifically, the programming current Iin provided from the data line driver 2 to the pixel circuit 11 has a level identical to the sum of the levels of the currents Ii1 to Ii3, which are ideally identical to those of the drive currents Idrv1 to Idrv3, respectively. This allow the programming current Iin to be relatively large, while reducing the instantaneous drive current through the OLED element 5, because the drive currents Idrivl to Idrv3 are sequentially provided through the OLED element 5. It should be noted that the conventional methods requires the level of the current developed on the data line to be identical to that the drive current developed through the OLED element 5.

For the case when the currents Ii1 to Ii3 have the same level, for example, the instantaneous drive current through the OLED element 5 is reduced down to one third of that of the aforementioned fifth conventional method for a given programming current. This effectively improves the lifetime of the OLED element 5. In a different aspect, the programming current developed through the associated data line 4 is increased up to three times as large as that of the aforementioned fifth conventional method for a given instantaneous drive current through the OLED element 5.

Accordingly, the pixel circuit architecture and operation procedure in-this embodiment effectively decrease the durations necessary for charging the data lines 4, while improving the lifetime of the OLED display.

Additionally, the pixel circuit architecture in this embodiment achieves precise control of the intensity of the OLED element 5 in the presence of the nonuniformity of the characteristics of the drive transistors. Although the drive currents Idrv1 to Idrv3 may differ from each other, the pixel circuit architecture in this embodiment maintains the gate to source voltages of the drive transistors Tr1 and Tr3 across the capacitors Cs1 to Cs3 so that the sum of the drive currents Idrv1 to Idrv3 are ideally identical to the programming current Iin, which corresponds with the pixel data. This effectively allows the OLED element 5 to emit light at the desired intensity.

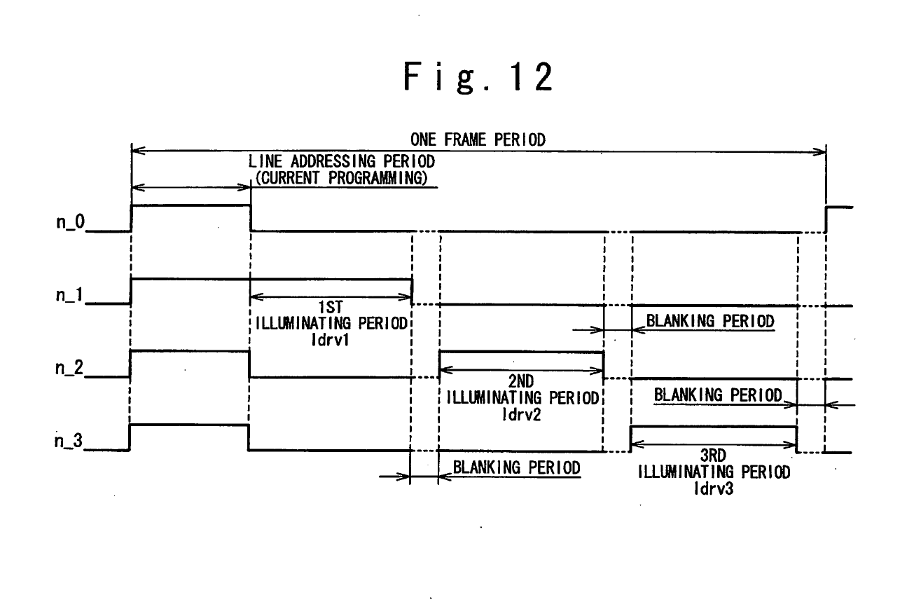

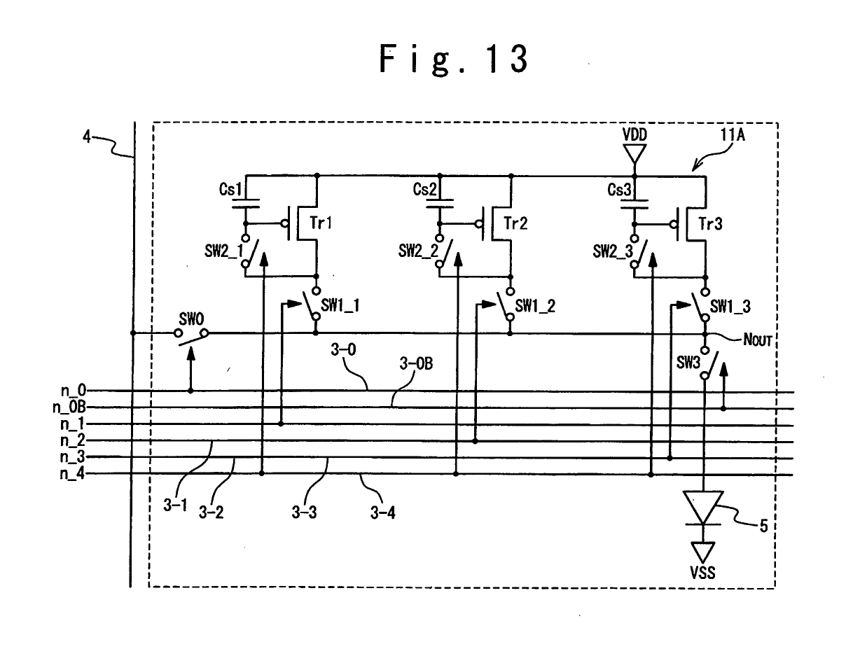

In a preferred embodiment, as shown in FIG. 12, another blanking period may be additionally inserted between the first and second illuminating periods. This effectively avoids the change in the intensity between the first and second illuminating periods being visually recognized, because the inserted blanking period prevents the comparison of the intensity between the first and second illuminating periods.

The same goes for the second and third illuminating periods; still another blanking period may be additionally inserted between the second and third illuminating periods.

Providing the additional blanking period(s) may be achieved through deactivating the scan signals n_0 to n_3. Instead, the scan signal n_0B may be deactivated during the additional blanking period(s) It should be noted that the technique of providing the additional blanking period(s) also applies other embodiments described in the following.

It should be also noted that the capacitors Cs1 to Cs1 are connected to another interconnection having a constant voltage in place of the power source VDD. This also applies other embodiments described in the following.

### Second Embodiment

In a second embodiment, the pixel circuit is modified so that the switches SW2_1 to SW2_3 are controlled in response to a scan signal n_4 transmitted through a scan line 3-4 from the scan line driver 1, in place of the scan signal n_0, which is used to control the switch SW0; the modified pixel circuit is designated by numeral 11A. The architecture of the pixel circuit 11A allows the switches SW2_1 to SW2_3 to be turned on and off independently of the switch SW0.

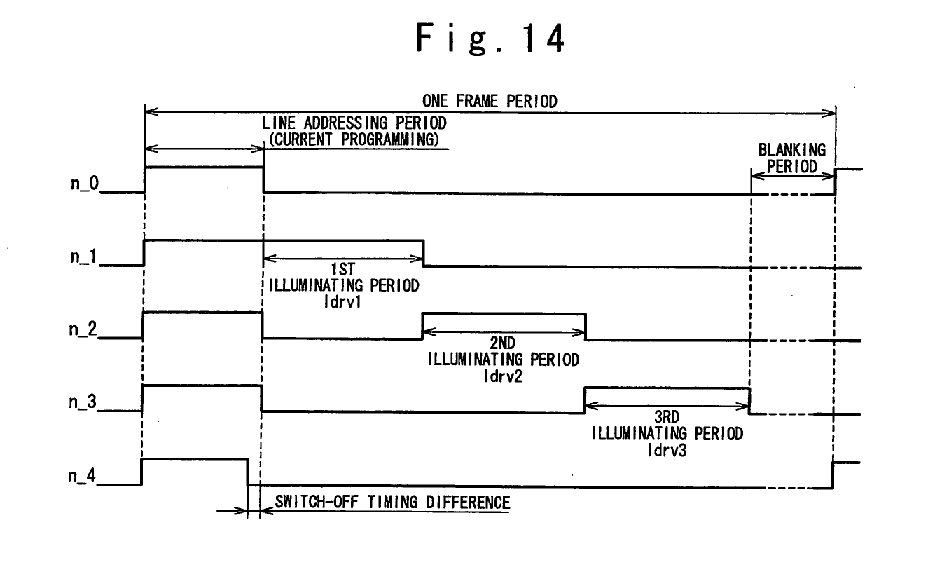

FIG. 14 is a timing chart illustrating an exemplary operation of the pixel circuit 11A in the second embodiment. In this embodiment, the scan signals n_0 to n_4 are activated to turn on the switches SW0, SW1_1 to SW1_3, and SW2_1 to SW2_3 at the beginning of the line addressing period. This allows the capacitors Cs1 to Cs3 to be programmed in response to the programming current Iin.

The essential difference between the first and second embodiments is that the scan signal n_4 is deactivated before the scan signal n_0 is deactivated, and thereby the switches SW2_1 to SW2_3 are turned off before the switches SW0, SW1_2, and SW1_3 are turned off.

The operation procedure of the pixel circuit 11A in the second embodiment is identical to that in first embodiment except for this difference.

An advantage of the operation procedure in the second embodiment is that the programmed voltages across the capacitors Cs1 to Cs3 are almost free from noise caused by the turn-off of other switches, including the switches SW0, SW1_2 and SW_3. Turning off the switches SW2_1 to SW2_3 in advance achieves electrical isolation of the capacitors Cs1 to Cs3 from the switches SW0, SW1_2 and SW_3 before the switches SW0, SW1_2 and SW_3 are turned off. The electrical isolation effectively prevents the undesirable switching noise from interfering the capacitors Cs1 to Cs3. This achieves precise control of the driving currents Idrv1 to Idrv3, that is, the intensity of the OLED element 5.

### Third Embodiment

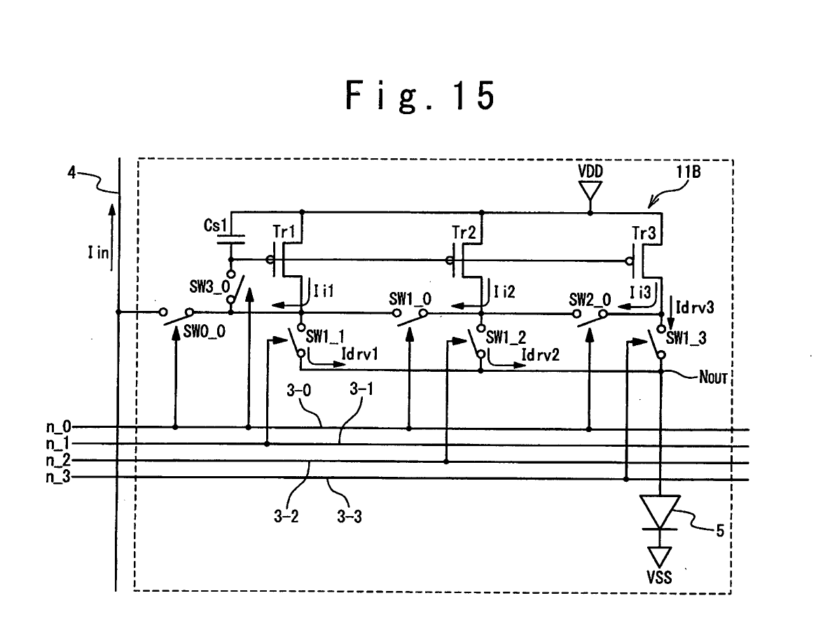

In a third embodiment, as shown in FIG. 15, the pixel circuit structure is modified from those in the first and second embodiments; the modified pixel circuit is denoted by numeral 11B. The major difference in the pixel circuit structure is that the pixel circuit 11B includes only one capacitor for programming the drive currents Idrv1 to Idrv3.

More specifically, the pixel circuit 11B includes PMOS drive transistors Tr1 to Tr3 coupled in parallel between a power source VDD and a current output node N_{OUT}. The sources of the driver transistors Tr1 to Tr3 are commonly connected to the power source VDD, while the drains are connected to the current output node N_{OUT} through switches SW1_1 to SW1_3, respectively. The gates of the driver transistors Tr1 to Tr3 are commonly connected to one terminal of a capacitor Cs. The other terminal of the capacitor Cs connected to the power source VDD.

The pixel circuit 11B further includes switches SW0_0, SW1_0, SW2_0, and SW3_0. The switch SW0_0 is connected between the data line 4 and the drain of the drive transistor Tr1. The switch SW1_0 is connected between the drains of the drive transistors Tr1 and Tr2, and the switch SW2_0 is connected between the drains of the drive transistors Tr2 and Tr3. The switch SW3_0 is connected between the gate and drain of the drive transistor Tr1.

The switches within the pixel circuit 11B, including the switches SW1_1 to SW1_3, SW0_0, SW1_0, SW2_0, and SW3_0 are controlled by four scan lines, designated by numerals 3-0, 3-1, 3-2, and 3-3, respectively. The switches SW1_1 to SW1_3 are connected to the scan lines 3-1 to 3-3 receiving scan signals n_1 to n_3 from the scan line driver 1, respectively. The switches SW0_0, SW1_0, SW2_0, and SW3_0, on the other hand, are connected to the scan line 3-0 receiving a scan signal n_0 from the scan line driver 1.

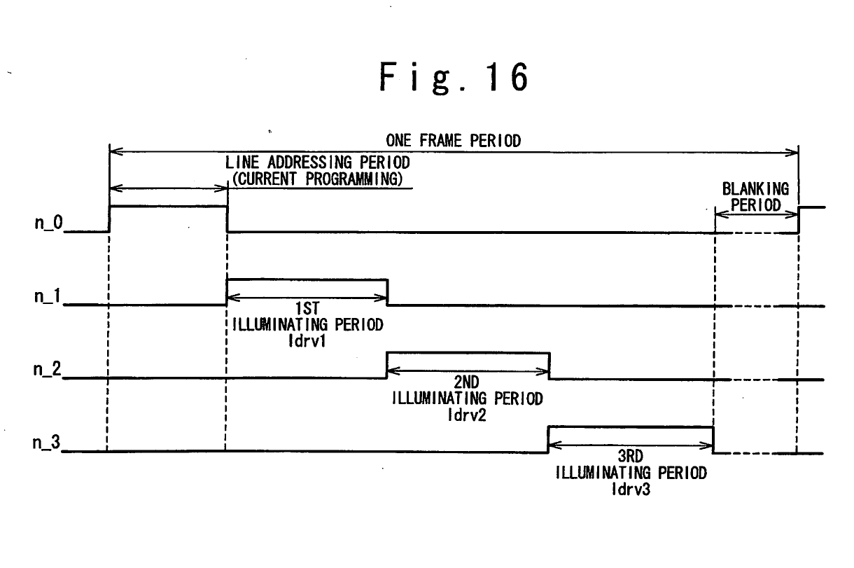

FIG. 16 is a timing chart illustrating an exemplary operation of the pixel circuit 11B in this embodiment. As is the case of the first embodiment, each frame period is divided into a line addressing period, first to third illuminating periods, and a blanking period.

During the line addressing period, the rows of the pixels are sequentially selected, and the capacitor C in each pixel is programmed in response to the associated pixel data. Specifically, the scan signals n_0 is activated to turn on the switches SW0_0, SW1_0, SW2_0, and SW3_0, and the scan signals n_1 to n_3 are deactivated to turn off the switches SW1_1 to SW1_3. This allows the drive transistors Tr1 to Tr3 to be connected in parallel between the associated data line 4 and the power source VDD with the gates and drains electrically connected.

Concurrently, a programming current Iin corresponding to the associated pixel data is provided for the pixel circuit 11B from the data line driver 2 through the associated data line 4. The programming current Iin is delivered to the drive transistors Tr1 to Tr3 to develop currents Ii1 to Ii3 through the drive transistors Tr1 to Tr3, respectively. This results in that the gate to source voltages of the drive transistors Tr1 to Tr3 settle to a common voltage that is necessary to drive the currents Ii1 to Ii3, respectively. The capacitor Cs is programmed to hold the gate to source voltage corresponding to the currents Ii1 to Ii3, respectively. At the end of the line addressing period, the scan line n_0 is deactivated to turn off the switches SW0_0, SW1_0, SW2_0, and SW3_0.

The line addressing period is followed by the first illuminating period. During the first illuminating period, the scan lines n_0, n_2, and n_3 are deactivated to turn off the switches SW0_0, SW1_0, SW2_0, SW3_0, SW1_2, and SW1_3, while the scan line n_1 is activated to turn on the switch SW1_1. This results in that the drive transistor Tr1 is connected between the power sources VDD and VSS. The drive transistor Tr1 is operated in saturation state to develop a drive current Idrv1 through the OLED element 5 so that the level of the drive current Idrv1 is identical to that of the current Ii1. This allows the OLED element 5 to emit light so that the intensity of the OLED element 5 depends on the drive current Idrv1 during the first illuminating period.

The first illuminating period is followed by the second illuminating period. During the second illuminating period, the scan signal n_2 is activated in place of the scan signal n_1, and thus the switch SW1_2 is turned on in place of the switch SW_1. This allows the drive transistor Tr2 to develop a drive current Idrv2 having a level identical to that of the current Ii2 through the OLED element 5. The OLED element 5 is driven by the drive current Idrv2 to emit light. The intensity of the OLED element 5 depends on the drive current Idrv2 during the second illuminating period.

Correspondingly, the second illuminating period is followed by the third illuminating period. During the second illuminating period, the scan signal n_3 is activated in place of the scan signal n_2, and thus the switch SW1_3 is turned on in place of the switch SW1_2. This allows the drive transistor Tr3 to develop a drive current Idrv3 having a level identical to that of the current Ii3 through the OLED element 5. The OLED element 5 is driven by the drive current Idrv3 to emit light. The intensity of the OLED element 5 depends on the drive current Idrv3 during the third illuminating period.

The third illuminating period is followed by the blanking period. During the blanking period, the scan signals n_0 to n_3 are deactivated to turn off the switches SW1_1 to SW1_3, SW0_0, SW1_0, SW2_0, and SW3_0. This results in that the drive transistors Tr1 to Tr3 are disconnected from the OLED element 5, and no drive current is provided for the OLED element 5. The OLED element 5 does not emit light during the blanking period.

This procedure is repeatedly performed for every frame period.

The pixel circuit architecture in this embodiment has the same advantages of that in the first embodiment; the architecture in this embodiment effectively increase the programming current Iin developed through the associated data line 4, while decreasing the instantaneous drive current through the OLED element 5. This effectively decreases the durations necessary for charging the data lines 4, while improving the lifetime of the OLED display. Additionally, the pixel circuit architecture in this embodiment achieves precise control of the intensity of the OLED element 5 in the presence of the nonuniformity of the characteristics of the drive transistors.

An additional advantage of the pixel circuit architecture in this embodiment is that the pixel circuit 11B consists of a reduced number of elements; the number of the scan lines provided for the each pixel circuit 11B is decreased by one compared to the first embodiment, and the number of the switches within the each pixel circuit 11B is also decreased by one. Additionally, the number of the capacitors within the each pixel circuit 11B is decreased by two. This effectively reduces the size of the each pixel circuit 11B.

In an alternative embodiment, the switch SW3_0 may be controlled independently of the switches SW0_0, SW1_0, and SW2_0 in response to another scan signal developed on another scan line (not shown). In this case, the switch SW3_0 is preferably turned off before the switches SW0_0, SW1_0, and SW2_0. As is the case of the aforementioned second embodiment, turning off the switch SW3_0 in advance of the turn-off of the switches SW0_0, SW1_0, and SW2_0 achieves electrical isolation of the capacitor Cs, and thus effectively reduces the undesirable change in the voltage across the capacitor Cs resulting from the switching noise of the switches SW0_0, SW1_0, and SW2_0.

### Fourth Embodiment

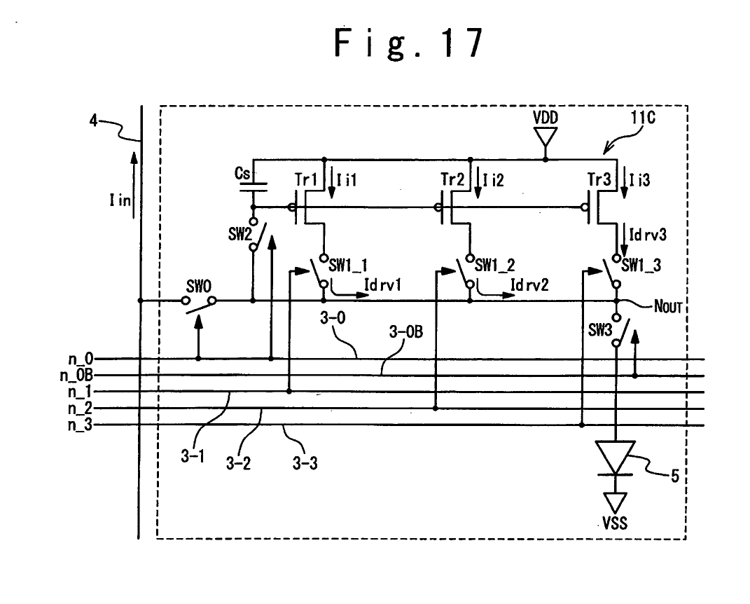

In a fourth embodiment, another pixel circuit structure is given which includes only one capacitor for programming the drive currents Idrv1 to Idrv3. As shown in FIG. 17, the pixel circuit in the fourth embodiment is denoted by numeral 11C.

The pixel circuit 11C is composed of three drive legs in parallel between a power source VDD and a current output node N_{OUT}, the drive legs being composed of PMOS drive transistors Tr1 to Tr3 with the gates thereof commonly coupled together. The sources of the driver transistors Tr1 to Tr3 are commonly connected to the power source VDD, while the drains are connected to the current output node N_{OUT} through switches SW1_1 to SW1_3, respectively. The gates of the driver transistors Tr1 to Tr3 are commonly connected to one terminal of a capacitor Cs. The other terminal of the capacitor Cs is connected to the power source VDD.

The pixel circuit 11C further includes switches SW0 and SW2. One terminal of the switch SW0 is connected to the associated data line 4, and the other terminal is connected to the current output node N_{OUT}. One terminal of the switch SW2 is connected to the other terminal of the switch SW0, while the other terminal of the switch SW2 is connected to the gates of the driver transistors Tr1 to Tr3.

The current output terminal N_{OUT} is connected to one terminal of an OLED element 5 through a switch SW3. The other terminal of the OLED element 5 is connected to a power source VSS.

The switches SW1_1 to SW1_3, SW0_0, SW1_0, SW2_0, and SW3_0 are controlled by five scan lines, designated by numerals 3-0, 3-0B, 3-1, 3-2, and 3-3, respectively. The switches SW1_1 to SW1_3 are connected to the scan lines 3-1 to 3-3 receiving scan signals n_1 to n_3 from the scan line driver 1, respectively. The switches SW0, and SW2, on the other hand, are connected to the scan line 3-0 receiving a scan signal n_0 from the scan line driver 1. Finally, the switch SW3 is connected to the scan line 3-0B receiving a scan signal n_0B from the scan line driver 1. The scan signal n_0B is complementary to the scan signal n_0.

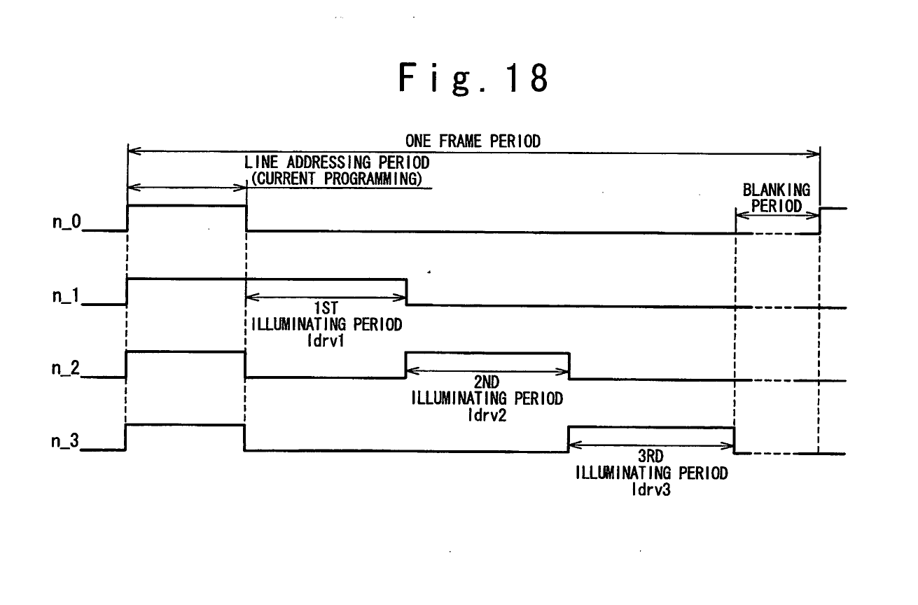

FIG. 18 is a timing chart illustrating an exemplary operation of the pixel circuit 11C in this embodiment. As is the case of the first embodiment, each frame period is divided into a line addressing period, first to third illuminating period, and a blanking period.

During the line addressing period, the rows of the pixels are sequentially selected, and the capacitor Cs in each pixel is programmed in response to the associated pixel data. Specifically, the scan signals n_0 to n_3 are activated to turn on the switches SW0, SW2, and SW1_1 to SW1_3. It should be noted that the scan signal n_0B, complementary to the scan signal n_0 is deactivated to turn off the switch SW3. This allows the drive transistors Tr1 to Tr3 to be connected in parallel between the data line 4 and the power source VDD with the gates and drains connected.

Concurrently, a programming current Iin corresponding to the associated pixel data is provided for the pixel circuit 11C from the data line driver 2 through the associated data line 4. The programming current Iin is delivered to the drive transistors Tr1 to Tr3 to develop currents Ii1 to Ii3 through the drive transistors Tr1 to Tr3, respectively. This results in that the common gate to source voltage of the drive transistors Tr1 to Tr3 settle to a voltage that is necessary to drive the currents Ii1 to Ii3. The capacitor Cs is programmed to hold the common gate to source voltage corresponding to the currents Ii1 to Ii3.

The line addressing period is followed by the first illuminating period. During the first illuminating period, the scan lines n_0, n_2, and n_3 are deactivated to turn off the switches SW0, SW2, SW1_2 and SW1_3, while the scan lines n_0B and n_1 are activated to turn on the switches SW1_1 and SW3. This results in that the drive transistor Tr1 is connected between the power sources VDD and VSS. The drive transistor Tr1 is operated in saturation state to develop a drive current Idrv1 through the OLED element 5 so that the level of the drive current Idrv1 is identical to that of the current Ii1. This allows the OLED element 5 to emit light so that the intensity of the OLED element 5 depends on the drive current Idrv1 during the first illuminating period.

The first illuminating period is followed by the second illuminating period. During the second illuminating period, the scan signal n_2 is activated in place of the scan signal n_1, and thus the switch SW1_2 is turned on in place of the switch SW1_1. This allows the drive transistor Tr2 to develop a drive current Idrv2 having a level identical to that of the current Ii2 through the OLED element 5. The OLED element 5 is driven by the drive current Idrv2 to emit light. The intensity of the OLED element 5 depends on the drive current Idrv2 during the second illuminating period.

Correspondingly, the second illuminating period is followed by the third illuminating period. During the second illuminating period, the scan signal n_3 is activated in place of the scan signal n_2, and thus the switch SW1_3 is turned on in place of the switch SW1_2. This allows the drive transistor Tr3 to develop a drive current Idrv3 having a level identical to that of the current Ii3 through the OLED element 5. The OLED element 5 is driven by the drive current Idrv3 to emit light. The intensity of the OLED element 5 depends on the drive current Idrv3 during the third illuminating period.

The third illuminating period is followed by the blanking period. During the blanking period, the scan signals n_0 to n_3 are deactivated to turn off the switches SW1_1 to SW1_3, the switches SW2_1 to SW2_3, and SW0 with the scan signal n_0B is activated to turn on the switch SW3. This results in that the drive transistors Tr1 to Tr3 are disconnected from the OLED element 5, and no drive current is provided for the OLED element 5. The OLED element 5 does not emit light during the blanking period.

This procedure is repeatedly performed for every frame period.

The pixel circuit architecture in this embodiment has the same advantages as the aforementioned third embodiment; the architecture in this embodiment effectively increase the programming current Iin developed through the associated data line 4, while decreasing the instantaneous drive current through the OLED element 5. This effectively decreases the durations necessary for charging the data lines 4, while improving the lifetime of the OLED display. Additionally, the pixel circuit architecture in this embodiment achieves precise control of the intensity of the OLED element 5 in the presence of the nonuniformity of the characteristics of the drive transistors. Furthermore, the pixel circuit 11C consists of a reduced number of elements; the number of the switches within the each pixel circuit 11C is decreased by two compared to the first embodiment, and the number of the capacitors within the each pixel circuit 11C is also decreased by two. This effectively reduces the size of the pixel circuit 11C.

As is the case of the third embodiment, the switch SW2 may be controlled independently of the switch SW0 in response to another scan signal developed on another scan line (not shown). In this case, the switch SW2 is preferably turned off before the switches SW0, SW1_2, and SW1_2 are turned off and the switch SW3 is turned on. Turning off the switch SW2 in advance of switching the switches SW0, SW1_2, SW1_3, and SW3 achieves electrical isolation of the capacitor Cs, and thus effectively reduces the undesirable change in the voltage across the capacitor Cs resulting from the switching noise of the switches SW0, SW1_2, SW1_2, and SW3.

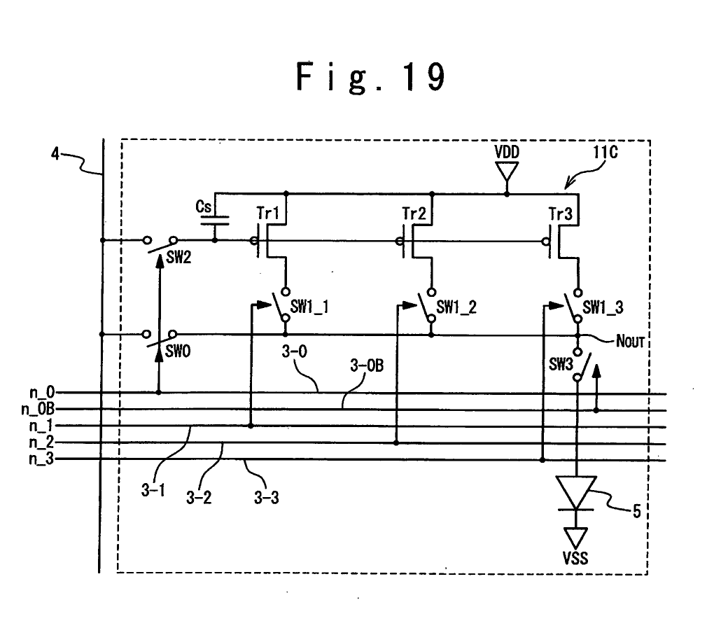

In an alternative embodiment, as shown in FIG. 19, the switch SW2 may be connected between the data line 4 and the gates of the drive transistors Tr1 to Tr3. Those skilled in the art would appreciate that this modification does not influence the operation of the pixel circuit 11C.

### Fifth Embodiment

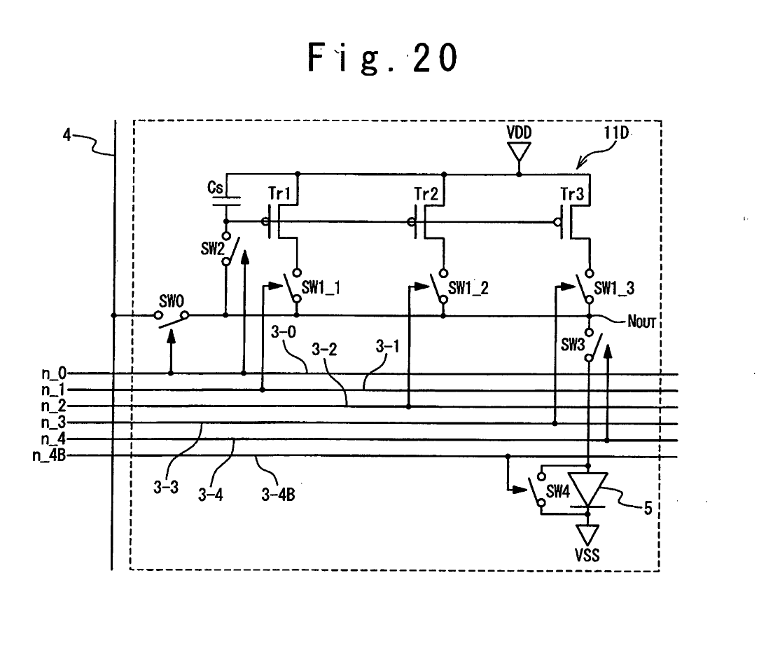

In a fifth embodiment, as shown in FIG. 20, the pixel circuit structure is modified from that in the fourth embodiment, so that a switch SW4 is connected in parallel to the OLED element 5; the modified pixel circuit is designated by numeral 11D. The switch SW4 is used to short-circuit the electrodes of the OLED element 5 at the beginning of the blanking period. This allows the OLED element 5 to rapidly stop emitting light when the blanking period is initiated. The OLED element 5 continues to emit light for a while after stopping providing the driver current because of the charges accumulated in the OLED element 5. This potentially causes an undesirable afterimage seen on the display panel. Short-circuiting the electrodes of the OLED element 5 effectively discharges the accumulated charges, and thereby allows the OLED element 5 to stop emitting light at the beginning of the blanking period.

Additional modification in the pixel circuit structure is as follows. In this embodiment, the switch SW3, which is connected between the current output node N_{OUT} and the OLED element 5, is connected to a scan line 3-4, and the switch SW4 is connected to a scan line 3-4B. Complementary scan signals n_4 and n_4B are provided from the scan line driver 1 on the scan lines 3-4 and 3-4B to exclusively turn on the switches SW3 and SW4.

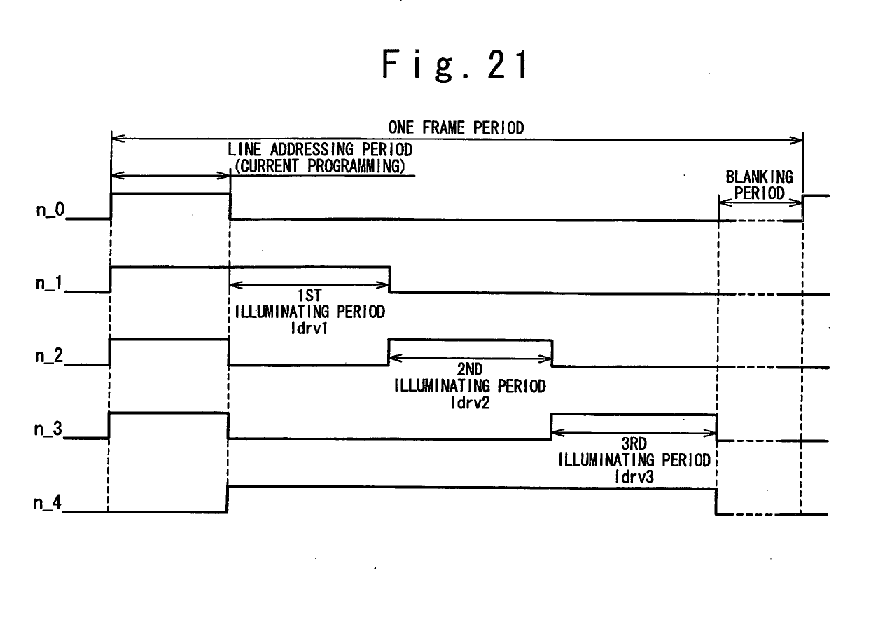

FIG. 21 is a timing chart illustrating an exemplary operation of the pixel circuit 11D in this embodiment. The operation in this embodiment is almost identical to that in the fourth embodiment in exception of the operations of the switches SW3 and SW4.

During the first to third illuminating periods, the scan signal n_4 is activated to turn on the switch SW3, and the scan signal n_4B is deactivated to turn off the switch SW4.

At the beginning of the blanking period, the scan signal n_4 is deactivated to turn off the switch SW3, and the scan signal n_4B is activated to turn on the switch SW4. This allows the OLED element 5 to be discharged, and thereby avoids the afterimage being seen on the display panel.

In an alternative embodiment, as is the case of the second embodiment, the switch SW2 may be controlled independently of the switches SW0 in response to another scan signal developed on another scan line (not shown). In this case, the switch SW2 is preferably turned off before the switches SW0, SW1_2, and SW1_3 are turned off and the switch SW3 is turned on. This effectively reduces the undesirable change in the voltage across the capacitor Cs resulting from the switching noise of the switches SW0, SW1_2, SW1_3, and SW3.

In still another alternative embodiment, the switch SW2 may be connected between the data line 4 and the gates of the drive transistors Tr1 to Tr3. Those skilled in the art would appreciate that this modification does not influence the operation of the pixel circuit 11C.

### Sixth Embodiment

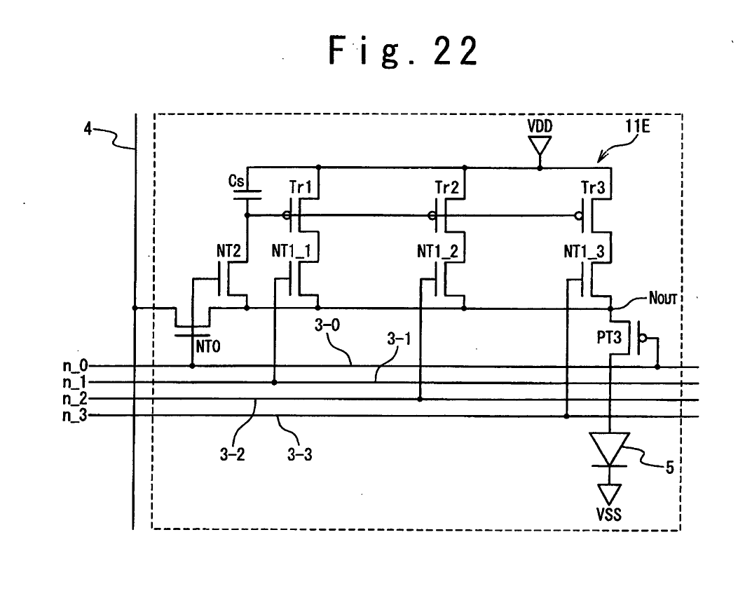

FIG. 22 is a block diagram of a pixel circuit 11E used in a sixth embodiment. The pixel circuit 11E is generally based on the pixel structure in the fourth embodiment (See FIG. 17). In this embodiment, TFT transistors are used as the switches within the pixel circuit 11E; specifically, NMOS transistors NT0, NT1_1, NT1_2, NT1_3, and NT2 are used as the switches SW0, SW1_1, SW1_2, SW1_3, and SW2, respectively, while a PMOS transistor PT3 is used as the switch SW3.

An important difference of the sixth embodiment from the fourth embodiment is that the PMOS transistor PT3 is connected to the scan line 3-0, and the scan line 3-0B is removed from the display panel. The fact that the NMOS and PMOS transistors NT0 and PT3 operate complementarily allows the removal of the scan line 3-0B. Removing the scan line n_0B from the display panel is preferable for improving the integration density of the display panel.

The operation of the pixel circuit 11E in this embodiment is almost identical to that in the fourth embodiment, except for that the scan signal n_0B is not provided for the pixel circuit 11E.

In an alternative embodiment, as is the case of the second embodiment, the NMOS transistor NT2 may be controlled independently of the NMOS transistor NT0 in response to another scan signal developed on another scan line (not shown). In this case, the NMOS transistor NT2 is preferably turned off before the NMOS transistors NT0, NT1_2, and NT1_3 are turned off and the PMOS transistor PT3 is turned on. This effectively reduces the undesirable change in the voltage across the capacitor Cs resulting from the switching noise of the NMOS transistors NT0, NT1_2, and NT1_3, and the PMOS transistor PT3.

In another alternative embodiment, the NMOS transistor NT2 may be connected between the associated data line 4 and the commonly coupled gates of the drive transistors Tr1 to Tr3, similarly to the pixel circuit shown in the FIG. 12.

### Seventh Embodiment

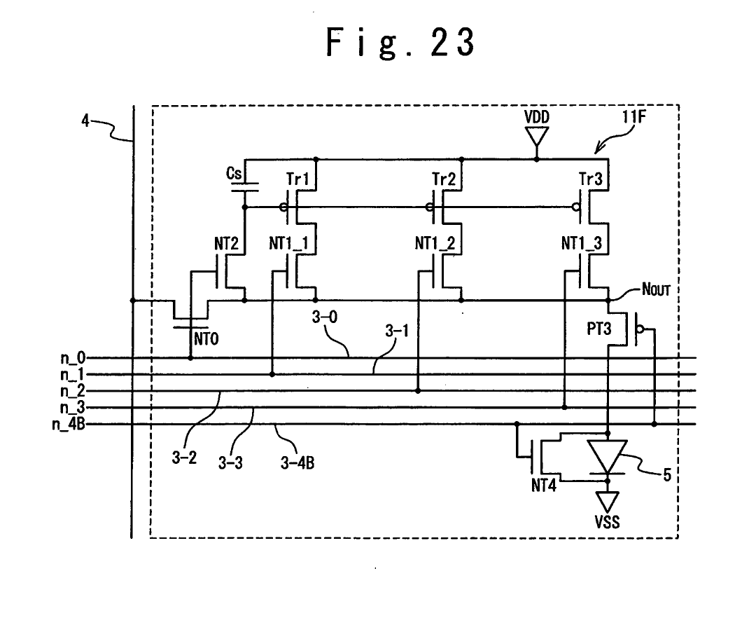

FIG. 23 is a circuit diagram of a pixel circuit 11F used in a seventh embodiment. The pixel circuit 11F is generally based on the pixel structure in the fifth embodiment (See FIG. 20). In this embodiment, TFT transistors are used as the switches within the pixel circuit 11F; specifically, NMOS transistors NT0, NT1_1, NT1_2, NT1_3, NT2, and NT4 are used as the switches SW0, SW1_1, SW1_2, SW1_3, SW2, and SW4, respectively, while a PMOS transistor PT3 is used as the switch SW3.

An important difference of the seventh embodiment from the fifth embodiment is that the PMOS transistor PT3 is connected to the scan line 3-4B, and the scan line 3-4 is removed from the display panel. The fact that the PMOS and NMOS transistors PT3 and NT4 operate complementarily allows the removal of the scan line 3-4. Removing the scan line n_4 from the display panel is preferable for improving the integration density of the display panel.

The operation of the pixel circuit 11F in this embodiment is almost identical to that in the fifth embodiment, except for that the scan signal n_4 is not provided for the pixel circuit 11F.

In an alternative embodiment, as is the case of the second embodiment, the NMOS transistor NT2 may be controlled independently of the NMOS transistor NT0 in response to another scan signal developed on another scan line (not shown). In this case, the NMOS transistor NT2 is preferably turned off before the NMOS transistors NT0, NT1_2, and NT1_3 are turned off and the PMOS transistor PT3 is turned on. This effectively reduces the undesirable change in the voltage across the capacitor Cs resulting from the switching noise of the NMOS transistors NT0, NT1_2, and NT1_3, and the PMOS transistor PT3.

In another alternative embodiment, the NMOS transistor NT2 may be connected between the associated data line 4 and the commonly coupled gates of the drive transistors Tr1 to Tr3, similarly to the pixel circuit shown in the FIG. 12.

### Eighth Embodiment

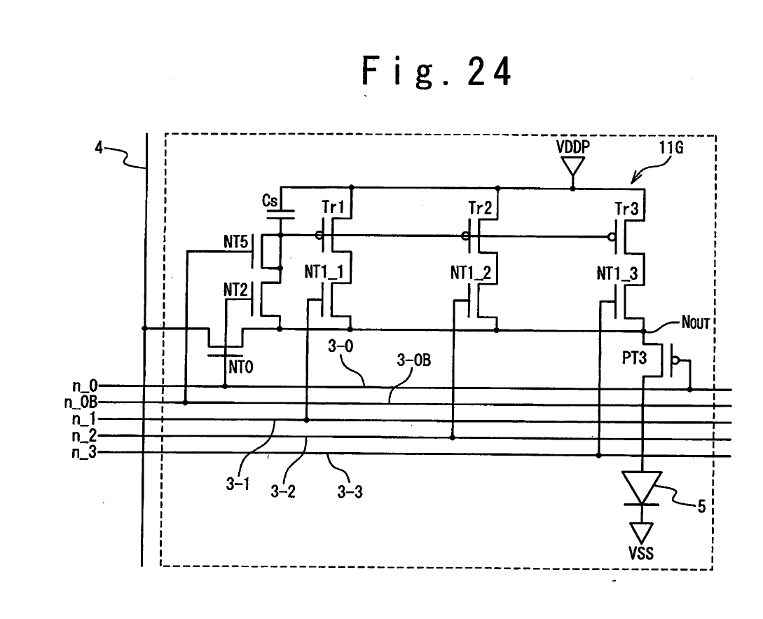

In an eighth embodiment, as shown in FIG. 24, the pixel circuit structure is modified from that of the sixth embodiment shown in FIG. 22 so that an additional TFT transistor NT5, which is an NMOS transistor, is connected between the NMOS transistor NT2 and the capacitor Cs. The NMOS transistor NT5 is connected to a scan line 3-0B receiving a scan signal n_0B complementary to the scan signal n_0, which is used for switching the NMOS transistors NT0 and NT2. The source and drain of the NMOS transistor NT5 are connected each other, and this allows the NMOS transistor NT5 to function as a capacitor. The area of the gate of the NMOS transistor NT5 is half as large as that of the NMOS transistor NT2. For example, the NMOS transistor NT5 may be designed so that the gate width of the NMOS transistor NT5 is half as wide as that of the NMOS transistor NT2 while the gate length of the NMOS transistor NT5 is identical that of the NMOS transistor NT2.

The NMOS transistor NT5 addresses reducing an undesirable change in the programmed voltage developed across the capacitor Cs, which is potentially caused by the charge transfer from the NMOS transistor NT2 to the capacitor Cs. When being turned on, the NMOS transistor NT2 accumulates negative charges in the channel region. When the NMOS transistor NT2 is turned on, the negative charges accumulated within the NMOS transistor NT2 are potentially transferred to the capacitor Cs, and this may cause an undesirable voltage drift across the capacitor Cs. The NMOS transistor NT5 receives the negative charges accumulated within the NMOS transistor NT2 when the NMOS transistor NT2 is turned off, and thereby avoids the programmed voltage across the capacitor Cs being undesirably changed.

The operation of the pixel circuit 11G in this embodiment is almost identical to that in the sixth embodiment, except for that the NMOS transistor NT5 is responsive to the scan signal n_0B, which is complementary to the scan signal n_0, used for controlling the NMOS transistor NT2. The gate of the NMOS transistor NT5 is set high when the NMOS transistor NT2 is turned off, and this allows the NMOS transistor NT5 to collect the negative charges accumulated in the channel region of the NMOS transistor NT2, and thereby avoids the undesirable voltage drift across the capacitor Cs.

In this embodiment, a switch may be additionally disposed in parallel to the OLED element 5 for short-circuiting the electrodes of the OLED element 5 as disclosed in the seventh embodiment. In this case, an additional scan signal is provided for the additional switch. This effectively reduces the duration necessary for stop emitting light from the OLED element 5 at the beginning of the blanking period.

In an alternative embodiment, as is the case of the second embodiment, the NMOS transistor NT2 may be controlled independently of the NMOS transistor NT0 in response to another scan signal developed on another scan line (not shown). In this case, the scan signal used for controlling the NMOS transistor NT5 is developed to be complementary to the scan signal used for the NMOS transistor NT2. In this case, the NMOS transistors NT2 and NT5 are preferably switched before the NMOS transistors NT0, NT1_2, NT1_3, and the PMOS transistor PT3 are switched at the end of the line addressing period. This effectively reduces the undesirable change in the voltage across the capacitor Cs resulting from the switching noise of the NMOS transistors NT0, NT1_2, and NT1_3, and the PMOS transistor PT3.

In another alternative embodiment, the NMOS transistor NT2 may be connected between the associated data line 4 and the commonly coupled gates of the drive transistors Tr1 to Tr3, similarly to the pixel circuit shown in the FIG. 12.

### Ninth Embodiment

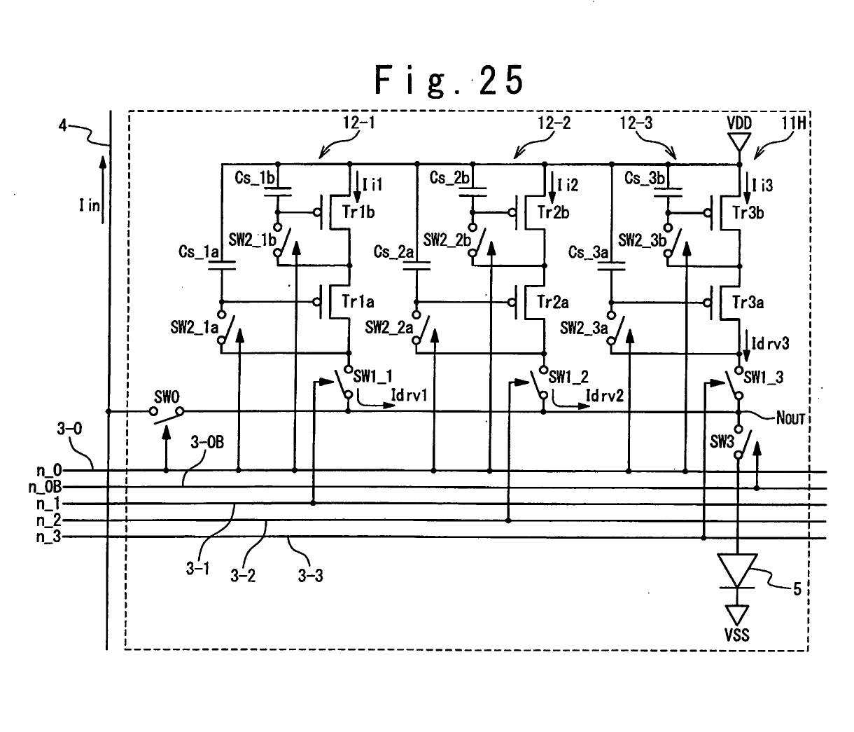

In a ninth embodiment, as shown in FIG. 25, the pixel circuit is modified so that each drive leg includes cascade-connected drive transistors; the modified pixel circuit is denoted by numeral 11H, hereinafter.

More specifically, the pixel circuit 11H includes drive legs 12-1, 12-2, and 12-3 connected in parallel between a power source VDD and a current output node N_{OUT}. The drive leg 12-1 includes drive transistors Tr1a and Tr1b connected in series. The drive transistor Tr1b has a source connected to the power source VDD, a drain connected to a source of the drive transistor Tr1a. The drain of the drive transistor Tr1a is connected to the current output node N_{OUT} through a switch SW1_1. Correspondingly, the drive leg 12-2 includes drive transistors Tr2a and Tr2b connected in series. The drive transistor Tr2b has a source connected to the power source VDD, a drain connected to a source of the drive transistor Tr2a. The drain of the drive transistor Tr2a is connected to the current output node N_{OUT} through a switch SW1_2. Finally, the drive leg 12-3 includes drive transistors Tr3a and Tr3b connected in series. The drive transistor Tr3b has a source connected to the power source VDD, a drain connected to a source of the drive transistor Tr3a. The drain of the drive transistor Tr3a is connected to the current output node N_{OUT} through a switch SW1_3.

Capacitors Cs_1a to Cs_3a and Cs_1b to Cs_3b are disposed for programming drive currents to be provided for the OLED element 5 as the voltages thereacross. The capacitors Cs_1a, Cs_2a, and Cs_3a are connected between the power source VDD and the gates of the drive transistors Tr1a, Tr2a, and Tr3a, respectively. Correspondingly, the capacitors Cs_1b, Cs_2b, and Cs_3b are connected between the power source VDD and the gates of the driver transistors Tr1b, Tr2b, and Tr3b.

Switches SW2_1a to SW2_3a, and SW2_1b to SW2_3b are disposed between the gates and drains of the drive transistors Tr1a to Tr3a, and Tr1b to Tr3b, respectively. The switches SW2_1a to SW2_3a, and SW2_1b to SW2_3b provide connections between the gates and drains of the drive transistors Tr1a to Tr3a, and Tr1b to Tr3b, while the capacitors Cs_1a to Cs_3a and Cs_1b to Cs_3b are programmed.

The current output node N_{OUT} is coupled to one terminal of the OLED element 5 through a switch SW3. The other terminal of the OLED element 5 is connected to a power source VSS. The switch SW3 is used to allow a drive current to be provided for the OLED element 5.

Finally, the current output node N_{OUT} is coupled to the associated data line 4 through a switch SW0. The switch SW0 provides a current path for programming the capacitors Cs1 to Cs3.

The switches SW1_1 to SW1_3, SW2_1a to SW2_3a, SW2_1b to SW2_3b, SW3, and SW0 are controlled by five scan lines, designated by numerals 3-0, 3-0B, 3-1, 3-2, and 3-3, respectively. The switches SW1_1 to SW1_3 are connected to the scan lines 3-1 to 3-3 receiving scan signals n_1 to n_3 from the scan line driver 1, respectively. The switches SW2_1a to SW2_3a and SW2_1b to SW2_3b are connected to the scan line 3-0 receiving a scan signal n_0 from the scan line driver 1. Finally, the switches SW3 and SW0 are connected to the scan lines 3-0B and 3-0, respectively. The scan line 3-0B receives a scan signal n_0B complementary to the scan signal n_0 from the scan line driver 1.

The operation of the pixel circuit 11H in this embodiment is similar to that in the first embodiment. During the line addressing period, the switches SW0, SW1_1 to SW1_3, SW2_1a to SW2_3a, and SW2_1b to SW2_3b are turned on through activating the scan signals n_0 to n_3 with the switch SW3 turned off. A programming current Iin is concurrently delivered to the cascade-connected drive transistors to develop currents Ii1, Ii2, Ii3; the current Ii1 being developed through the drive transistors Tr1a and Tr1b, the current Ii2 being developed through the drive transistors Tr2a and Tr2b, and the current Ii3 being developed through the drive transistors Tr3a and Tr3b. This allows the gate to source voltages of the drive transistors Tr1a to Tr3a, and Tr1b to Tr3b are programmed across the capacitors Cs_1a to Cs_3a, and Cs_1b to Cs_3b, respectively, so as to drive the currents Ii1 to Ii3. After programming the capacitors Cs_1a to Cs_3a, and Cs_1b to Cs_3b, the drive currents Idrv1 to Idrv3 which are identical to the currents Ii1 to 1i3 are sequentially provided for the OLED element 5 from the drive transistors Tr1a to Tr3a, and Tr1b to Tr3b.

An advantage of the pixel circuit 11H in this embodiment is that the cascade-connections of the drive transistors allows the drive current through the OLED element 5 to be less dependent on the power supply voltage developed on the power source VDD, and also allows the intensity of the OLED element 5 to be less dependent on the drive current therethrough.

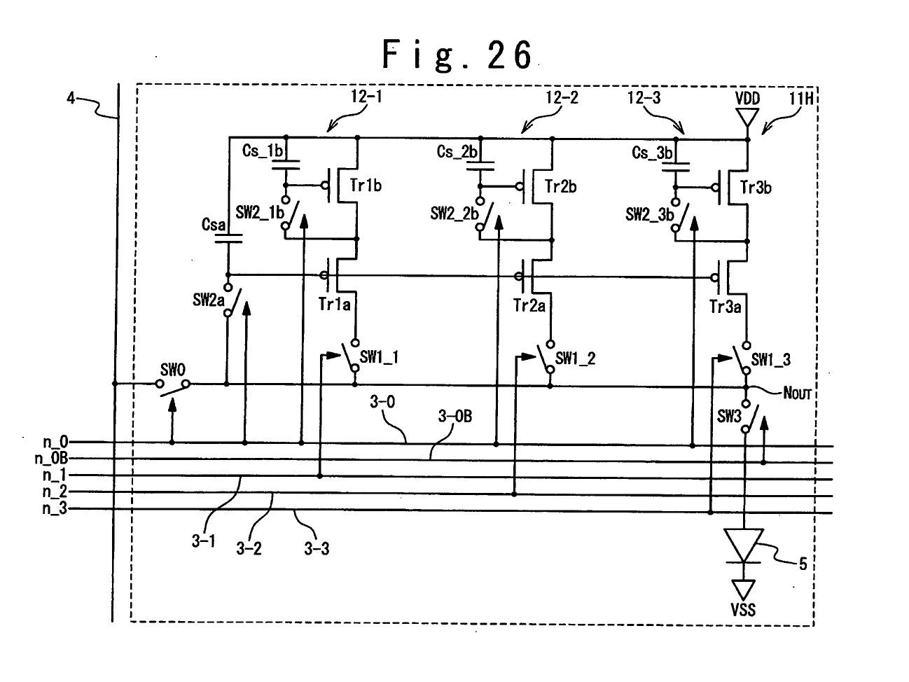

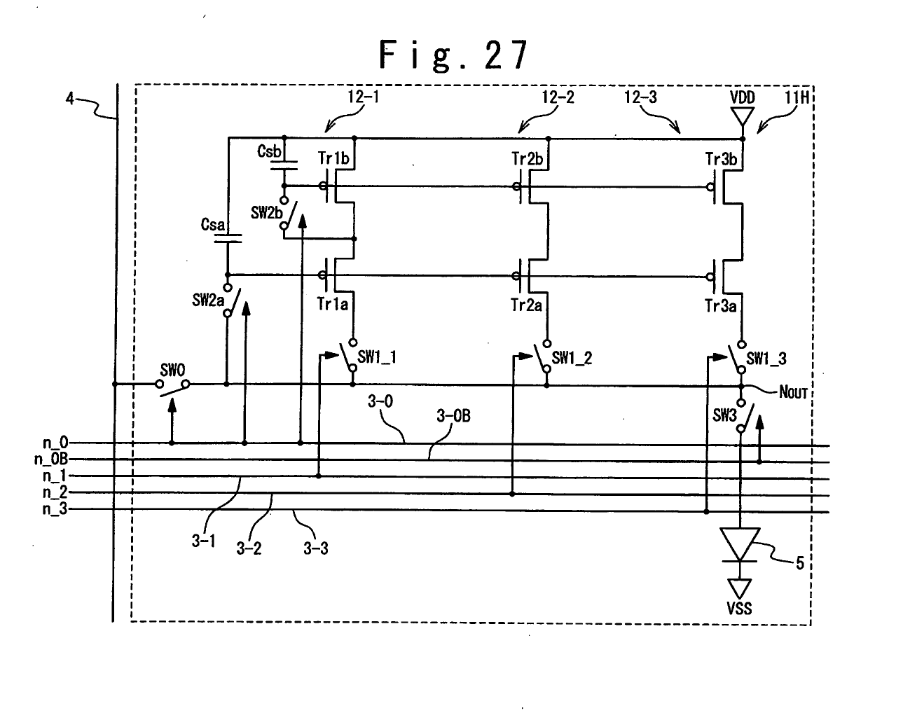

In alternative embodiments, the number of the capacitors may be reduced as shown in FIGS. 26 and 27. Referring to FIG. 26, the gates of the drive transistors Tr1a to Tr3a may be coupled together, and a capacitor Csa may be disposed between the commonly coupled gates and the power source VDD. In this case, a switch SW2a may be connected between the capacitor Csa and the switch SW0, and also connected to the scan line 3-0. The switch SW2a is responsive to the scan signal n_0.

The pixel circuit structure shown in FIG. 27 addresses further reducing the number of the capacitors; the gates of the drive transistors Tr1b to Tr3b may be coupled together, and a capacitor Csb may be disposed between the commonly coupled gates and the power source VDD. In this case, a switch SW2b may be connected between the capacitor Csb and one of the drains of the drive transistors Tr1b to Tr3b, and also connected to the scan line 3-0. The switch SW2b is responsive to the scan signal n_0.

For both of the pixel circuit structure shown in FIGS. 26 and 27, the switch SW2a may be connected between the associated data line 4 and the commonly coupled gates, similarly to the third embodiment shown in FIG. 15.

In these embodiment, a switch may be additionally disposed in parallel to the OLED element 5 for short-circuiting the electrodes of the OLED element 5 as disclosed in the seventh embodiment. In this case, an additional scan signal is provided for the additional switch. This effectively reduces the duration necessary for stop emitting light from the OLED element 5 at the beginning of the blanking period. More preferably, a pair of complementary MOS transistors are used as the additional switch connected in parallel to the OLED element 5, and the switch SW3 connected between the current output node N_{OUT} and the OLED element 5. This allows the control of these switches using a common scan signal and thus effectively reduces the number of the scan lines.

### Tenth Embodiment.

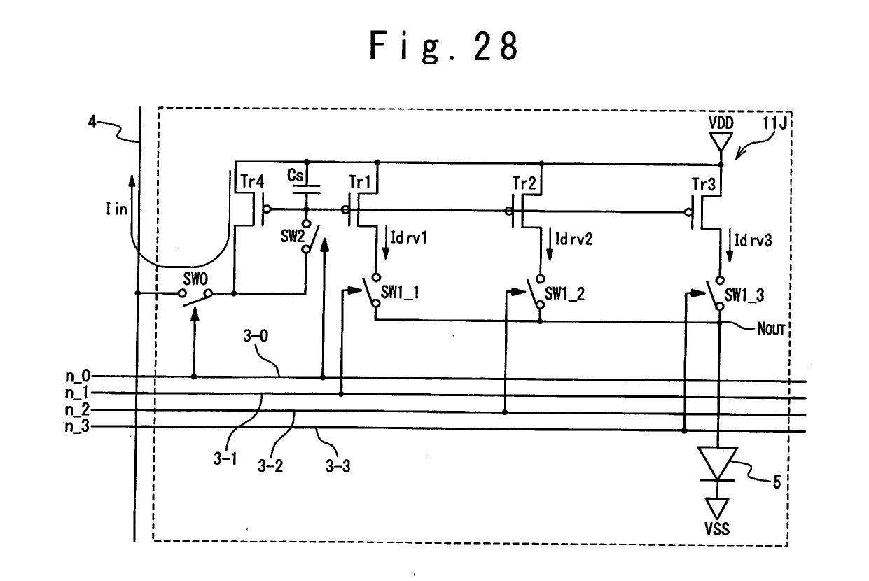

In a tenth embodiment, as shown in FIG. 28, the pixel circuit structure is modified so that the pixel circuit, designated by numeral 11J, is composed of a current programming PMOS transistor used for programming the capacitor within the pixel circuit.

Specifically, the pixel circuit 11J includes three drive legs connected in parallel between a power source VDD and a current output node N_{OUT}, the drive legs being composed of PMOS drive transistors Tr1, Tr2, and Tr3, respectively. The gates of the drive transistors Tr1, Tr2 and Tr3 are commonly coupled together. The sources of the drive transistors Tr1, Tr2 and Tr3 are commonly coupled to the power source VDD, and the drains of the drive transistors Tr1, Tr2 and Tr3 are connected to the current output node N_{OUT} through switches SW1_1, SW1_2, and SW1_3, respectively.

A capacitor Cs is connected between the power source VDD and the commonly coupled gates of the drive transistors Tr1, Tr2 and Tr3.

Additionally, a current programming PMOS transistor Tr4 is disposed within the pixel circuit. The source of the current programming transistor Tr4 is connected to the power source VDD, and the drain is connected to the associated data line 4 through a switch SW0. The gate of the current programming transistor Tr4 is connected to the commonly coupled gates of the drive transistors Tr1, Tr2 and Tr3. The gate and drain of the current programming transistor Tr4 are connected each other through a switch SW2.

The dimensions of the transistors Tr1 to Tr4 are determined so that the transistors Tr1 to Tr4 have the substantially same drive capability. In one embodiment, the transistors Tr1 to Tr4 are designed so that the transistors Tr1 to Tr4 have the same gate length and width.

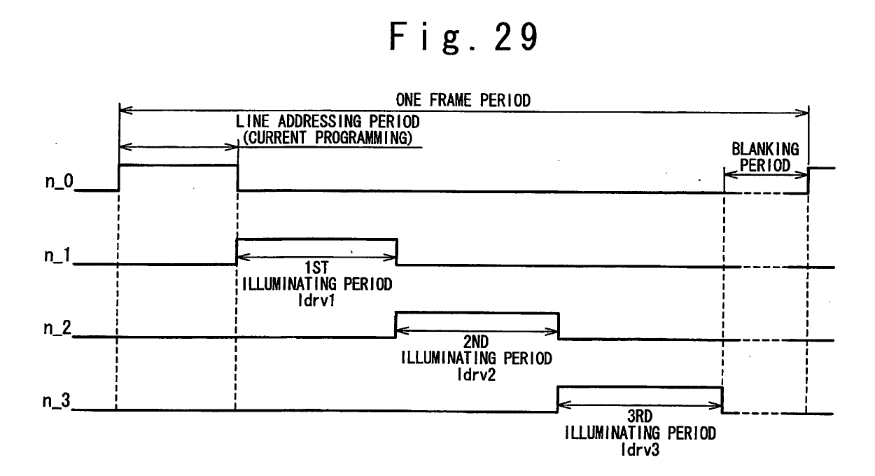

FIG. 29 is a timing diagram illustrating an exemplary operation of the pixel circuit 11J in this embodiment. As is the case of the first to ninth embodiment, each frame period is divided into a line addressing period, first to third illuminating period, and a blank period.

During the line addressing period, the scan signal n_0 is activated to turn on the switches SW0 and SW2, and the scan signals n_1 to n_3 are deactivated to turn off the switches SW1_1 to SW1_3. This allows the current programming transistor SW4 to be electrically connected between the data line 4 and the power source VDD. Concurrently, a programming current Iin, corresponding to the pixel data, is provided for the pixel circuit 11J through the data line 4. The programming current Iin flows through the current programming transistor Tr4. The programming current Iin develops a gate to source voltage between the gate and source of the transistor Tr4, and thereby programs the capacitor Cs to hold a voltage necessary to drive the current Iin.

The line addressing period is followed by the first illuminating period. During the first illuminating period, the scan signal n_0 is deactivated to turn off the switches SW0 and SW2, and the scan signal n_1 is activated to turn on the switch SW1_1; the switches SW1_2 and SW1_3 are kept turned off. This allows the drive transistor Tr1 to develop a drive current Idrv1 through the OLED element 5. The level of the drive current Idrv1 is substantially identical to that of the programming current Iin, because the characteristics of the drive transistor Tr1 is substantially identical to those of the current programming Tr4. The OLED element 5 emits light so that the intensity of the OLED element 5 depends on the level of the drive current Idrv1, that is, the level of the programming current Iin.

The first illuminating period is followed by the second illuminating period. During the second illuminating period, the scan signal n_2 is activated in place of the scan signal n_1 to thereby turn on the switch SW1_2 in place of the switch SW1_1. This allows the drive transistor Tr2 to develop a drive current Idrv2 through the OLED element 5. As is the case of the drive current Idrv1, the level of the drive current Idrv1 is substantially identical to that of the programming current Iin. The OLED element 5 emits light so that the intensity of the OLED element 5 depends on the level of the drive current Idrv2, that is, the level of the programming current Iin.

Correspondingly, the second first illuminating period is followed by the third illuminating period. During the third illuminating period, the scan signal n_3 is activated in place of the scan signal n_2 to thereby turn on the switch SW1_3 in place of the switch SW1_2. This allows the drive transistor Tr3 to develop a drive current Idrv3 through the OLED element 5. As is the case of the drive currents Idrv1 and Idrv2, the level of the drive current Idrv3 is substantially identical to that of the programming current Iin. The OLED element 5 emits light so that the intensity of the OLED element 5 depends on the level of the drive current Idrv3, that is, the level of the programming current Iin.

In this embodiment, the rapid drive of the data line 4 is not achieved with reduced instantaneous drive current, because the instantaneous drive current through the OLED element 5 is identical to the programming current Iin.

However, the pixel circuit structure in this embodiment is also preferable for reducing the non-uniformity of the intensity of the pixel because of the use of the multiple drive transistors in parallel. The variation in the average of the currents through the thin film transistors disposed on the display panel 10 for a given gate to source voltage is smaller than the variation of the individual currents. Considering transistor sets each including three transistors, the maximum to minimum difference in the averages of the drive capabilities of the transistor sets is smaller than that in the individual drive capabilities. Accordingly, the pixel circuit structure involving the use of the multiple drive transistors effectively reduces the non-uniformity of the intensity of the pixel.

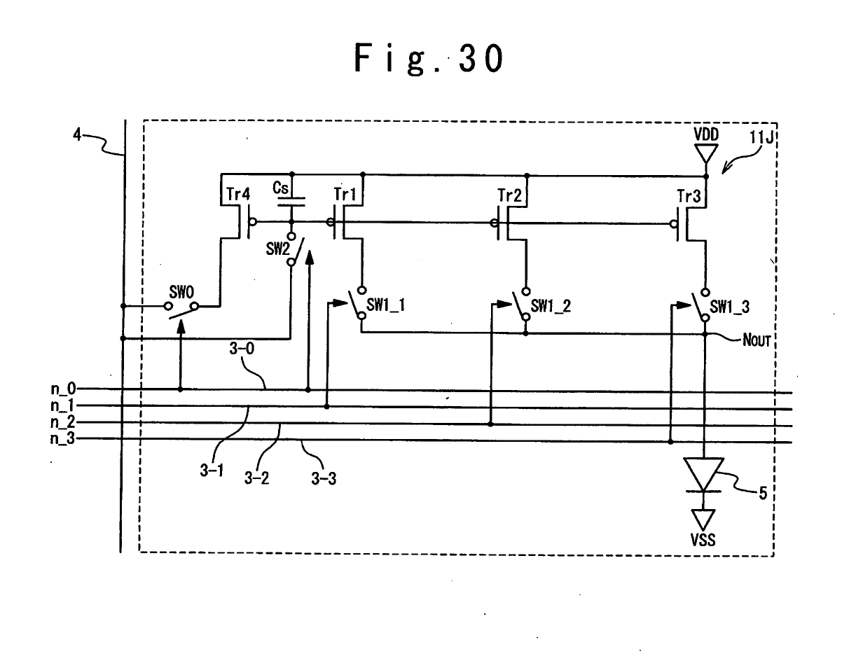

In an alternative embodiment, as illustrated in FIG. 30, the switch SW2 may be connected between the data line 4 and the commonly connected gates of the transistors Tr1 to Tr4. Those skilled in the art would appreciate that this modification causes no substantial change in the operation of the pixel circuit.

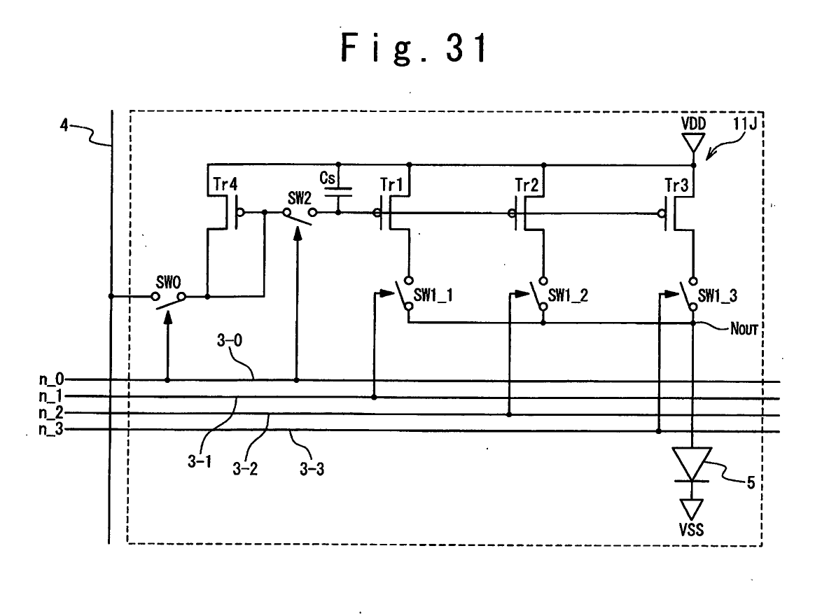

In another alternative embodiment, as illustrated in FIG. 31, the pixel circuit structure may be modified so that the gate and drain of the current programming transistor Tr4 are commonly coupled together, and the switch SW2 is connected between the gate of the current programming transistor Tr4 and the commonly coupled gates of the drive transistors Tr1 to Tr3. Those skilled in the art would appreciate that this modification also causes no substantial change in the operation of the pixel circuit.

Although the invention has been described in its preferred form with a certain degree of particularity, it is understood that the present disclosure of the preferred form has been changed in the details of construction and the combination and arrangement of parts may be resorted to without departing from the scope of the invention as hereinafter claimed.

Especially, it should be noted that a technical concept disclosed in one of the first to tenth embodiment may apply to another if not causing inconsistency. For example, the technique disclosed in the second embodiment, which addresses electrically isolating the programming capacitor(s) before the other switches, may apply to the other embodiments. It should be additionally noted that the technique disclosed in the fifth and seventh embodiments, which address short-circuiting the electrodes of the OLED element 5, may apply to the other embodiment.

1. A display device comprising:
a data line driver;
a scan line driver; and
a display panel including a plurality of drive legs between a current output node and a first node having a fixed potential, each of said drive legs comprising:
a drive transistor having a source connected to said first node,
a capacitor connected between a gate of said drive transistor and a second node having a fixed potential,
a first switch connected between said current output node and a drain of said drive transistor, and
a second switch connected between said gate and said drain of said drive transistor,
wherein said display panel further includes:
a data line,
a third switch connected between said current output node and said data line,
a current-driven element, and
a fourth switch connected between said current output node and said current-driven element,
wherein, during a programming period, said scan line driver turns on said first to third switches with-said fourth switch turned off, and said data line driver develops a programming current through said data line, and
wherein, during a driving period following said programming period, said scan line driver turns on said fourth switch with said second and third switches turned off, and sequentially turns on said first switches of said drive legs.

2. The display-device according to claim 1, wherein said second node is connected to said first node, and said fixed potential on said second node is identical to that on said first potential.

3. The display device according to claim 1, wherein said second switches are turned off at an end of said programming period before said third switch is turned off.

4. The display device according to claim 1, wherein, during a blanking period following said driving period, said scan line driver controls said first to fourth switches so that no drive current is provided for said current-driven element from said drive legs.

5. The display device according to claim 1, wherein said driving period includes:
first and second illuminating periods, and
an intermediate blanking period disposed between said first and second illuminating periods,
wherein, during said first illuminating period, said scan line driver turns on one of said first switches of said drive legs,
wherein, during said intermediate blanking period, said scan line driver controls said first to fourth switches so that no drive current is provided for said current-driven element from said drive legs, and
wherein, during said second illuminating period, said scan line driver turns on another of said first switches of said drive legs.

6. The display device according to claim 1, wherein each of said drive legs further comprises:
a cascading drive transistor having a source connected to said drain of said drive transistor, and a drain connected to said first switch,
another capacitor connected between a gate of said another drive transistor and a third node having a fixed potential.

7. The display device according to claim 6, wherein said third node is connected to said first node, and said fixed potential on said third node is identical to that on said first node.

8. The display device according to claim 1, wherein said display panel further includes another capacitor,
wherein each of said drive legs further comprises a cascading drive transistor having a source connected to said drain of said drive transistor, and a drain connected to said first switch with gates of said cascading drive transistors of said drive legs commonly coupled together, and
wherein said another capacitor is connected between said commonly coupled gates of said cascading drive transistors and a third node having a third potential.

9. The display device according to claim 8, wherein said third node is connected to said first node, and said fixed potential on said third node is identical to that on said first node.

10. The display device according to claim 8, wherein said display panel further includes another switch connected between said commonly coupled gates and said current output node,
wherein said scan line driver turns on said another switch during said programming period.

11. The display device according to claim 1, wherein said current-driven element includes an OLED element.

12. A display device comprising:
a data line driver;
a scan line driver; and
a display panel,
wherein said display panel includes a plurality of drive legs connected between a current output node and a first node having a fixed potential, each of said drive legs including:
a drive transistor having a source connected to said first node, and
a first switch connected between said current output node and a drain of said drive transistor,
wherein gates of said drive transistors of said drive legs are commonly coupled together,
wherein said display panel further includes:
a capacitor connected between said commonly coupled gates and a second node having a fixed potential,
a current-driven element connected to said current output node,
a data line, and
a third switch connected between said data line and said drains of said drive transistors of said drive legs,
wherein, during a programming period, said scan line driver turns on said first and third switches, and said data line driver provides a programming current through said data line to develop currents through said drive transistors of said drive legs, and
wherein, during a driving period following said programming period, said scan line driver sequentially turns on said first switches of said drive legs with said third switch turned off.

13. The display device according to claim 12, wherein said second node is connected to said first node, and said fixed potential on said second node is identical to that on said first potential.

14. The display device according to claim 12, wherein said display panel further includes:
a set of second switches for providing electrical connections among said drains of said drive transistors of said drive legs, and
a fourth switch connected between said commonly coupled gates and one of said drains of said drive transistors,
wherein said scan line driver turns on said set of second switches and said fourth switch during said programming period, while turning off said set of second switches and said fourth switch during said driving period.

15. The display device according to claim 12, wherein said display panel further includes a second switch connected between said commonly coupled gates of said drive transistors and said current output node,
wherein said third switch is connected between said current output node and said data line, and
wherein said scan line driver turns on said second switch during said programming period, while turning off said second switch during said driving period.

16. The display device according to claim 15, wherein said display panel further includes a first MOS transistor having a source and a drain coupled together, said source and drain being connected to said commonly coupled gates of said drive transistors,
wherein said second switch includes a second MOS transistor, one of a source and a drain of said second MOS transistor being connected to said source and drain of said first MOS transistor, and another being connected to said current output node.

17. The display device according to claim 12, wherein said display panel further includes a second switch connected between said commonly coupled gates of said drive transistors and said data line,
wherein said third switch is connected between said current output node and said data line, and
wherein said scan line driver turns on said second switch during said programming period, while turning off said second switch during said driving period.

18. The display device according to claim 12, wherein said display panel further includes a fifth switch connected in parallel to said current-driven element, and
wherein, during a blanking period following said driving period, said scan line driver controls said first and third switches with said fifth switch turned on, so that no drive current is provided for said current-driven element from said drive legs.

19. The display device according to claim 12, wherein said display panel further includes another capacitor,
wherein each of said drive legs further including a cascading drive transistor having a source connected to said drain of said drive transistor, and a drain connected to said first switch,
wherein said gates of said cascading drive transistors of said drive legs are commonly coupled together,
wherein said another capacitor is connected between said commonly coupled gates of said cascading drive transistors and a third node having a fixed potential, and
wherein said third switch is connected between said data line and said current output node.

20. The display device according to claim 19, wherein said third node is connected to said first node, and said fixed potential on said third node is identical to that on said first node.

21. A display device comprising:
a data line driver;
a scan line driver; and
a display panel,
wherein said display panel includes a plurality of drive legs connected between a current output node and a first node having a fixed potential, each of said drive legs including:
a drive transistor having a source connected to said first node, and
a first switch connected between said current output node and a drain of said drive transistor,
wherein gates of said drive transistors of said drive legs are commonly coupled together,
wherein said display panel further includes:
a capacitor connected between said commonly coupled gates and a second node having a fixed potential,
a programming transistor having a gate connected to said commonly coupled gates, and a source connected to said first node,
a current-driven element connected to said current output node,
a data line, and
a third switch connected between said data line and said drain of said programming transistor,
wherein, during a programming period, said scan line driver turns on said first and third switches, and said data line driver provides a programming current for said programming transistor through said data line, and
wherein, during a driving period following said programming period, said scan line driver sequentially turns on said first switches of said drive legs with said third switch turned off.

22. The display device according to claim 21, wherein said display panel further includes comprising a second switch disposed between said gate and drain of said programming transistor, and
wherein said scan line driver turns on said second switch during said programming period, while turning off said second switch during said driving period.

23. The display device according to claim 21, wherein said display panel further includes a second switch disposed between said data line and said gate of said programming transistor, and
wherein said scan line driver turns on said second switch during said programming period, while turning off said second switch during said driving period.

24. The display device according to claim 21, wherein said display panel further includes a second switch disposed between said commonly coupled gates of said drive transistors and said gate of said programming transistor, and
wherein said scan line driver turns on said second switch during said programming period, while turning off said second switch during said driving period.

25. A display panel comprising:
a plurality of drive legs between a current output node and a first node having a fixed potential, each of said drive legs including:
a drive transistor having a source connected to said first node,
a capacitor connected between a gate of said drive transistor and a second node having a fixed potential,
a first switch connected between said current output node and a drain of said drive transistor, and
a second switch connected between said gate and said drain of said drive transistor;
a data line;
a third switch connected between said current output node and said data line;
a current-driven element;
a fourth switch connected between said current output node and said current-driven element.

26. The display panel according to claim 25, wherein said third switch is connected to a first scan line;
said second switches of said drive legs are connected to a second scan line different from said first scan line.

27. The display panel according to claim 25, wherein each of said drive legs further comprises:
a cascading drive transistor having a source connected to said drain of said drive transistor, and a drain connected to said first switch,
another capacitor connected between a gate of said another drive transistor and a third node having a fixed potential.

28. The display panel according to claim 25, further comprising another capacitor,
wherein each of said drive legs further comprises a cascading drive transistor having a source connected to said drain of said drive transistor, and a drain connected to said first switch with gates of said cascading drive transistors of said drive legs commonly coupled together, and
wherein said another capacitor is connected between said commonly coupled gates of said cascading drive transistors and a third node having a third potential.

29. The display panel according to claim 28, further comprising another switch connected between said commonly coupled gates and said current output node.

30. The display panel according to claim 25, wherein said current-driven element includes an OLED element.

31. A display panel comprising:
a plurality of drive legs connected between a current output node and a first node having a fixed potential, each of said drive legs including:
a drive transistor having a source connected to said first node with gates of said drive transistors of said drive legs commonly coupled together, and
a first switch connected between said current output node and a drain of said drive transistor;
a capacitor connected between said commonly coupled gates and a second node having a fixed potential;
a current-driven element connected to said current output node;
a data line;
a third switch connected between said data line and said drains of said drive transistors of said drive legs.

32. The display panel according to claim 31, further comprising:
a set of second switches for providing electrical connections among said drains of said drive transistors of said drive legs; and
a fourth switch connected between said commonly coupled gates and one of said drains of said drive transistors.

33. The display panel according to claim 31, further comprising a second switch connected between said commonly coupled gates of said drive transistors and said current output node,
wherein said third switch is connected between said current output node and said data line.

34. The display panel according to claim 33, further comprising a first MOS transistor having a source and a drain coupled together, said source and drain being connected to said commonly coupled gates of said drive transistors,
wherein said second switch includes a second MOS transistor, one of a source and a drain of said second MOS transistor being connected to said source and drain of said first MOS transistor, and another being connected to said current output node.

35. The display panel according to claim 31, further comprising a second switch connected between said commonly coupled gates of said drive transistors and said data line,
wherein said third switch is connected between said current output node and said data line.

36. The display panel according to claim 31, further comprising a fifth switch connected in parallel to said current-driven element.

37. The display panel according to claim 31, further comprising another capacitor,
wherein each of said drive legs further including a cascading drive transistor having a source connected to said drain of said drive transistor, and a drain connected to said first switch,
wherein said gates of said cascading drive transistors of said drive legs are commonly coupled together,
wherein said another capacitor is connected between said commonly coupled gates of said cascading drive transistors and a third node having a fixed potential, and
wherein said third switch is connected between said data line and said current output node.

38. The display panel according to claim 37, wherein said third node is connected to said first node, and said fixed potential on said third node is identical to that on said first node.

39. A display panel comprising:
a plurality of drive legs connected between a current output node and a first node having a fixed potential, each of said drive legs including:
a drive transistor having a source connected to said first node, and
a first switch connected between said current output node and a drain of said drive transistor, wherein gates of said drive transistors of said drive legs are commonly coupled together,
a capacitor connected between said commonly coupled gates and a second node having a fixed potential,
a programming transistor having a gate connected to said commonly coupled gates, and a source connected to said first node,
a current-driven element connected to said current output node,
a data line,
a third switch connected between said data line and said drain of said programming transistor.

40. The display panel according to claim 39, further comprising a second switch disposed between said gate and drain of said programming transistor.

41. The display device according to claim 39, further comprising a second switch disposed between said data line and said gate of said programming transistor.

42. The display device according to claim 39, further comprising a second switch disposed between said commonly coupled gates of said drive transistors and said gate of said programming transistor.

43. A method for driving a current-driven element comprising:
providing a programming current through a data line during a programming period;
delivering said programming current from said data line to a plurality of drive transistors during said programming period, each of said drive transistors having a gate connected to a capacitor, to thereby develop a voltage across said each capacitor;
sequentially selecting one of said plurality of drive transistors to provide a drive current for said current-drive element from said selected drive transistor with said voltage maintained across said each capacitor, during a driving period following said programming period.

44. The method according to claim 43, further comprising:
providing no drive current for said current-drive element from said plurality of drive transistors during a blanking period following said driving period.

45. The method according to claim 44, further comprising:
short-circuiting electrodes of said current-drive element during said blanking period.

46. The method according to claim 43, wherein said driving period includes:
first and second illuminating periods, and
an intermediate blanking period disposed between said first and second illuminating periods,
wherein, during said first illuminating period, said drive current is provided for said current-drive element from one of said plurality of drive transistors,
wherein, during said intermediate blanking period, no drive current is provided for said current-drive element from said plurality of drive transistors, and
wherein, during said second illuminating period, said drive current is provided for said current-drive element from another of said plurality of drive transistors.

47. The method according to claim 43, further comprising:
disconnecting said plurality of drive transistors from said data line; and
disconnecting said capacitors from said data line before said plurality of drive transistors are disconnected from said data line.

48. A method for driving a current-driven element comprising:
providing a programming current through a data line during a programming period;
delivering said programming current from said data line to a plurality of drive transistors having commonly coupled gates connected to a capacitor during said programming period, to thereby develop a voltage across said capacitor;
sequentially selecting one of said plurality of drive transistors to provide a drive current for said current-drive element from said selected drive transistor with said voltage maintained across said capacitor, during a driving period following said programming period.

49. The method according to claim 48., further comprising:
providing no drive current for said current-drive element from said plurality of drive transistors during a blanking period following said driving period.

50. The method according to claim 49, further comprising:
short-circuiting electrodes of said current-drive element during said blanking period.

51. The method according to claim 48, wherein said driving period includes:
first and second illuminating periods, and
an intermediate blanking period disposed between said first and second illuminating periods,
wherein, during said first illuminating period, said drive current is provided for said current-drive element from one of said plurality of drive transistors,
wherein, during said intermediate blanking period, no drive current is provided for said current-drive element from said plurality of drive transistors, and
wherein, during said second illuminating period, said drive current is provided for said current-drive element from another of said plurality of drive transistors.

52. The method according to claim 48, further comprising:
disconnecting said plurality of drive transistors from said data line; and
disconnecting said capacitors from said data line before said plurality of drive transistors are disconnected from said data line.

53. A circuit comprising:
a light emitting element; and
a pixel circuit for applying a current to said light emitting element, said pixel circuit including:
a plurality of current sources each producing a current, and
a switch sequentially applying a corresponding current of said current sources to said light emitting element during one frame period.

54. The circuit according to claim 53, wherein said switch is controlled not to apply all of said currents of said current sources to said light emitting element during said one frame period.

55. The circuit according to claim 54, wherein said switch is controlled to provide a state_corresponding to a data for said plurality of current sources before said corresponding current is sequentially applied to said light emitting element.

56. The circuit according to claim 55, wherein said switch is controlled to render the states of said plurality of current sources stable before stopping providing said state corresponding to said data to said plurality of current sources.

57. A circuit comprising:
a current driven element; and
a driver sequentially supplying a current to said current driven element during a predetermined frame period.
